(19) United States
(12) Patent Application Publication
(10) Pub. No.: US 2022/0182681 A1
(43) Pub. Date: Jun. 9, 2022

(54) IMAGE OR VIDEO CODING BASED ON SUB-PICTURE HANDLING STRUCTURE

(71) Applicant: LG ELECTRONICS INC., Seoul (KR)

(72) Inventors: Seethal PALURI, Seoul (KR); Jongyeul SUH, Seoul (KR); Jaehyun LIM, Seoul (KR); Seunghwan KIM, Seoul (KR)

(21) Appl. No.: 17/442,358

(22) PCT Filed: Mar. 24, 2020
(86) PCT No.: PCT/KR2020/003987

§ 371 Date: Sep. 23, 2021

Related U.S. Application Data
(60) Provisional application No. 62/822,882, filed on Mar. 24, 2019.

(51) Int. Cl. H04N 19/82; H04N 19/176; H04N 19/105; H04N 19/70

(52) U.S. Cl. CPC H04N 19/82; H04N 19/70; H04N 19/105; H04N 19/176

(57) ABSTRACT

According to the disclosure of the present document, an image/video coding procedure may be performed on the basis of a sub-picture partitioning structure, and encoded image/video information may include individual information on each of subpictures. In addition, output sub-picture sets, each including sub-pictures, may be used for encoding or decoding of an image/video, whereby the overall image/video compression efficiency can be improved and the subjective/objective visual quality can be improved.

### BACKGROUND OF THE DISCLOSURE

### Field of the Disclosure

The present document relates to image or video coding based on sub-picture handling structure.

### Related Art

Recently, demand for high-resolution, high-quality image/video such as 4K or 8K or higher ultra high definition (UHD) image/video has increased in various fields. As image/video data has high resolution and high quality, the amount of information or bits to be transmitted increases relative to the existing image/video data, and thus, transmitting image data using a medium such as an existing wired/wireless broadband line or an existing storage medium or storing image/video data using existing storage medium increase transmission cost and storage cost.

In addition, interest and demand for immersive media such as virtual reality (VR) and artificial reality (AR) content or holograms has recently increased and broadcasting for image/video is having characteristics different from reality images such as game images has increased.

Accordingly, there is a demand for a flexible picture partitioning method that can be applied to efficiently compress and reproduce an image/video in an image/video application program having various recent characteristics.

In addition, there is a discussion on a technique for partitioning a picture for coding into subpictures in order to improve compression efficiency and increase subjective/objective visual quality. In order to efficiently apply these techniques, there is a need for a method for efficiently signaling related information.

### SUMMARY

According to an embodiment of the present document, a method and an apparatus for increasing image coding efficiency are provided.

According to an embodiment of the present document, a method and apparatus for applying a sub-picture partitioning structure are provided.

According to an embodiment of the present document, a method and an apparatus for signaling image/video information in units of sub-pictures are provided.

According to an embodiment of the present document, a method and apparatus for performing prediction and/or reconstruction based on a sub-picture partitioning structure are provided.

According to an embodiment of the present document, the image information may include a sequence parameter set (SPS), and the SPS may include information on the number of the sub-pictures for the current picture.

According to an embodiment of the present document, the SPS includes ID syntax elements of the sub-pictures, and the ID syntax elements may be derived based on information on the number of the sub-pictures.

According to an embodiment of the present document, filtering may be selectively performed on a boundary between subpictures in a coding procedure.

According to an embodiment of the present document, prediction and/or reconstruction may be performed based on an output subpicture set including subpictures in a coding procedure.

According to an embodiment of the present document, resampling may be performed for subpictures included in an output subpicture set in a coding procedure.

According to an embodiment of the present document, resampling of subpictures in SPS or picture parameter set (PPS) may be constrained in a coding procedure.

According to an embodiment of the present document, a video/image decoding method performed by a decoding apparatus is provided.

According to an embodiment of the present document, a decoding apparatus for performing video/image decoding is provided.

According to an embodiment of the present document, a video/image encoding method performed by an encoding apparatus is provided.

According to an embodiment of the present document, an encoding apparatus for performing video/image encoding is provided.

According to one embodiment of the present document, there is provided a computer-readable digital storage medium in which encoded video/image information, generated according to the video/image encoding method disclosed in at least one of the embodiments of the present document, is stored.

According to an embodiment of the present document, there is provided a computer-readable digital storage medium in which encoded information or encoded video/image information, causing to perform the video/image decoding method disclosed in at least one of the embodiments of the present document by the decoding apparatus, is stored.

### Advantageous Effects

According to an embodiment of the present document, overall image/video compression efficiency may be improved.

According to an embodiment of the present document, subjective/objective visual quality may be increased based on the sub-picture division structure.

According to an embodiment of the present document, a picture may include sub pictures, and separate information for each of the sub pictures may be included in the encoded image/video information. Accordingly, information for coding can be efficiently signaled.

According to an embodiment of the present document, a picture may have a subpicture partitioning structure, and filtering may be performed on a boundary between subpictures. Accordingly, the visual quality of the picture may be increased.

### BRIEF DESCRIPTION OF THE DRAWINGS

FIG. 1 illustrates an example of a video/image coding system to which the embodiments of the present document may be applied.

FIG. 2 is a diagram schematically illustrating a configuration of a video/image encoding apparatus to which the embodiments of the present document may be applied.

FIG. 3 is a diagram schematically illustrating a configuration of a video/image decoding apparatus to which the embodiments of the present document may be applied.

FIG. 4 exemplarily shows a picture including CTUs.

FIG. 5 exemplarily shows a hierarchical structure for a coded image/video.

FIG. 6 exemplarily shows a hierarchical structure of CVS.

FIG. 7 is a flowchart schematically illustrating an example of a picture encoding method.

FIG. 8 is a flowchart schematically illustrating an example of a picture decoding method.

FIG. 9 exemplarily shows a picture including subpictures.

FIG. 10 and FIG. 11 schematically illustrate an example of a video/image encoding method and related components according to embodiment(s) of the present document.

FIG. 12 and FIG. 13 schematically illustrate an example of an image/video decoding method and related components according to an embodiment of the present document.

FIG. 14 illustrates an example of a content streaming system to which embodiments disclosed in the present document may be applied.

### DESCRIPTION OF EXEMPLARY EMBODIMENTS

The present document may be modified in various forms, and specific embodiments thereof will be described and shown in the drawings. However, the embodiments are not intended for limiting the present document. The terms used in the following description are used to merely describe specific embodiments, but are not intended to limit the present document. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Meanwhile, each configuration in the drawings described in the present document is shown independently for the convenience of description regarding different characteristic functions, and does not mean that each configuration is implemented as separate hardware or separate software. For example, two or more components among each component may be combined to form one component, or one component may be divided into a plurality of components. Embodiments in which each component is integrated and/or separated are also included in the scope of the disclosure of the present document.

Hereinafter, examples of the present embodiment will be described in detail with reference to the accompanying drawings. In addition, like reference numerals are used to indicate like elements throughout the drawings, and the same descriptions on the like elements will be omitted.

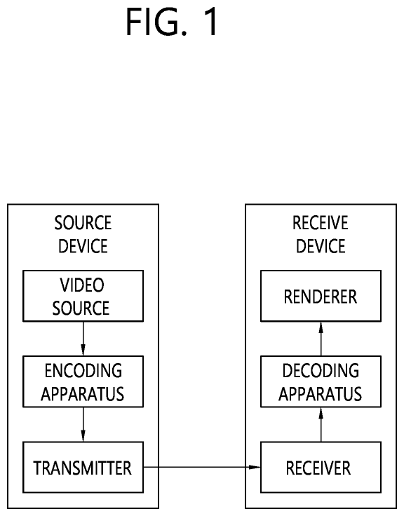

FIG. 1 illustrates an example of a video/image coding system to which the embodiments of the present document may be applied.

Referring to FIG. 1, a video/image coding system may include a first device (a source device) and a second device (a reception device). The source device may transmit encoded video/image information or data to the reception device through a digital storage medium or network in the form of a file or streaming.

The source device may include a video source, an encoding apparatus, and a transmitter. The receiving device may include a receiver, a decoding apparatus, and a renderer. The encoding apparatus may be called a video/image encoding apparatus, and the decoding apparatus may be called a video/image decoding apparatus. The transmitter may be included in the encoding apparatus. The receiver may be included in the decoding apparatus. The renderer may include a display, and the display may be configured as a separate device or an external component.

The video source may acquire video/image through a process of capturing, synthesizing, or generating the video/image. The video source may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding apparatus may encode input video/image. The encoding apparatus may perform a series of procedures such as prediction, transform, and quantization for compaction and coding efficiency. The encoded data (encoded video/image information) may be output in the form of a bitstream.

The transmitter may transmit the encoded image/image information or data output in the form of a bitstream to the receiver of the receiving device through a digital storage medium or a network in the form of a file or streaming. The digital storage medium may include various storage mediums such as USB, SD, CD, DVD, Blu-ray, HDD, SSD, and the like. The transmitter may include an element for generating a media file through a predetermined file format and may include an element for transmission through a broadcast/communication network. The receiver may receive/extract the bitstream and transmit the received bitstream to the decoding apparatus.

The decoding apparatus may decode the video/image by performing a series of procedures such as dequantization, inverse transform, and prediction corresponding to the operation of the encoding apparatus.

The renderer may render the decoded video/image. The rendered video/image may be displayed through the display.

The present document relates to video/image coding. For example, a method/embodiment disclosed in the present document may be applied to a method disclosed in the versatile video coding (VVC) standard, the essential video coding (EVC) standard, the AOMedia Video 1 (AV1) standard, the 2nd generation of audio video coding standard (AVS2) or the next generation video/image coding standard (e.g., H.267, H.268, or the like).

The present document suggests various embodiments of video/image coding, and the above embodiments may also be performed in combination with each other unless otherwise specified.

In the present document, a video may refer to a series of images over time. A picture generally refers to the unit representing one image at a particular time frame, and a slice/tile refers to the unit constituting a part of the picture in terms of coding. A slice/tile may include one or more coding tree units (CTUs). One picture may consist of one or more slices/tiles. One picture may consist of one or more tile groups. One tile group may include one or more tiles. A brick may represent a rectangular region of CTU rows within a tile in a picture. A tile may be partitioned into a multiple bricks, each of which may be constructed with one or more CTU rows within the tile. A tile that is not partitioned into multiple bricks may also be referred to as a brick. A brick scan may represent a specific sequential ordering of CTUs partitioning a picture, wherein the CTUs may be ordered in a CTU raster scan within a brick, and bricks within a tile may be ordered consecutively in a raster scan of the bricks of the tile, and tiles in a picture may be ordered consecutively in a raster scan of the tiles of the picture. A tile is a rectangular region of CTUs within a particular tile column and a particular tile row in a picture. The tile column is a rectangular region of CTUs having a height equal to the height of the picture and a width specified by syntax elements in the picture parameter set. The tile row is a rectangular region of CTUs having a height specified by syntax elements in the picture parameter set and a width equal to the width of the picture. A tile scan is a specific sequential ordering of CTUs partitioning a picture in which the CTUs are ordered consecutively in CTU raster scan in a tile whereas tiles in a picture are ordered consecutively in a raster scan of the tiles of the picture. A slice includes an integer number of bricks of a picture that may be exclusively contained in a single NAL unit. A slice may consists of either a number of complete tiles or only a consecutive sequence of complete bricks of one tile. In the present document, a tile group and a slice may be used in place of each other. For example, in the present document, a tile group/tile group header may be referred to as a slice/slice header.

Meanwhile, one picture may be divided into two or more subpictures. A subpicture may be a rectangular region of one or more slices within a picture.

A pixel or a pel may mean a smallest unit constituting one picture (or image). Also, ‘sample’ may be used as a term corresponding to a pixel. A sample may generally represent a pixel or a value of a pixel, and may represent only a pixel/pixel value of a luma component or only a pixel/pixel value of a chroma component.

A unit may represent a basic unit of image processing. The unit may include at least one of a specific region of the picture and information related to the region. One unit may include one luma block and two chroma (ex. cb, cr) blocks. The unit may be used interchangeably with terms such as block or area in some cases. In a general case, an M×N block may include samples (or sample arrays) or a set (or array) of transform coefficients of M columns and N rows. Alternatively, the sample may mean a pixel value in the spatial domain, and when such a pixel value is transformed to the frequency domain, it may mean a transform coefficient in the frequency domain.

In the present document, “A or B” may mean “only A”, “only B” or “both A and B”. In other words, “A or B” in the present document may be interpreted as “A and/or B”. For example, in the present document “A, B or C (A, B or C)” means “only A”, “only B”, “only C”, or “any combination of A, B and C”.

A slash (/) or comma (comma) used in the present document may mean “and/or”. For example, “A/B” may mean “A and/or B”. Accordingly, “A/B” may mean “only A”, “only B”, or “both A and B”. For example, “A, B, C” may mean “A, B, or C”.

In the present document, “at least one of A and B” may mean “only A”, “only B” or “both A and B”. Also, in the present document, the expression “at least one of A or B” or “at least one of A and/or B” may be interpreted the same as “at least one of A and B”.

Also, in the present document, “at least one of A, B and C” means “only A”, “only B”, “only C”, or “any combination of A, B and C”. Also, “at least one of A, B or C” or “at least one of A, B and/or C” may mean “at least one of A, B and C”.

Also, parentheses used in the present document may mean “for example”. Specifically, when “prediction (intra prediction)” is indicated, “intra prediction” may be proposed as an example of “prediction”. In other words, “prediction” in the present document is not limited to “intra prediction”, and “intra prediction” may be proposed as an example of “prediction”. Also, even when “prediction (i.e., intra prediction)” is indicated, “intra prediction” may be proposed as an example of “prediction”.

Technical features that are individually described in one drawing in the present document may be implemented individually or simultaneously.

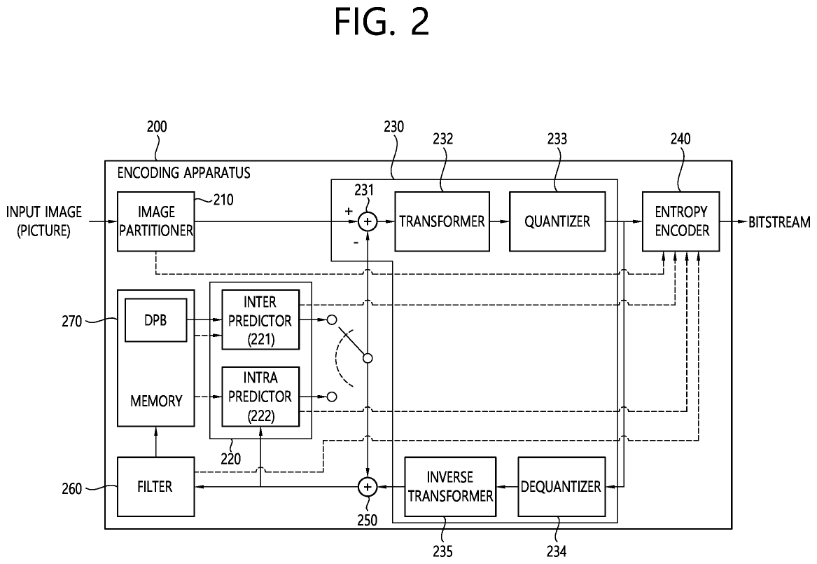

FIG. 2 is a diagram schematically illustrating a configuration of a video/image encoding apparatus to which the embodiments of the present document may be applied. Hereinafter, what is referred to as the video encoding apparatus may include an image encoding apparatus.

Referring to FIG. 2, the encoding apparatus 200 includes an image partitioner 210, a predictor 220, a residual processor 230, and an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or a reconstructed block generator. The image partitioner 210, the predictor 220, the residual processor 230, the entropy encoder 240, the adder 250, and the filter 260 may be configured by at least one hardware component (ex. An encoder chipset or processor) according to an embodiment. In addition, the memory 270 may include a decoded picture buffer (DPB) or may be configured by a digital storage medium. The hardware component may further include the memory 270 as an internal/external component.

The image partitioner 210 may partition an input image (or a picture or a frame) input to the encoding apparatus 200 into one or more processors. For example, the processor may be called a coding unit (CU). In this case, the coding unit may be recursively partitioned according to a quad-tree binary-tree ternary-tree (QTBTTT) structure from a coding tree unit (CTU) or a largest coding unit (LCU). For example, one coding unit may be partitioned into a plurality of coding units of a deeper depth based on a quad tree structure, a binary tree structure, and/or a ternary structure. In this case, for example, the quad tree structure may be applied first and the binary tree structure and/or ternary structure may be applied later. Alternatively, the binary tree structure may be applied first. The coding procedure according to the present disclosure may be performed based on the final coding unit that is no longer partitioned. In this case, the largest coding unit may be used as the final coding unit based on coding efficiency according to image characteristics, or if necessary, the coding unit may be recursively partitioned into coding units of deeper depth and a coding unit having an optimal size may be used as the final coding unit. Here, the coding procedure may include a procedure of prediction, transform, and reconstruction, which will be described later. As another example, the processor may further include a prediction unit (PU) or a transform unit (TU). In this case, the prediction unit and the transform unit may be split or partitioned from the aforementioned final coding unit. The prediction unit may be a unit of sample prediction, and the transform unit may be a unit for deriving a transform coefficient and/or a unit for deriving a residual signal from the transform coefficient.

The unit may be used interchangeably with terms such as block or area in some cases. In a general case, an M×N block may represent a set of samples or transform coefficients composed of M columns and N rows. A sample may generally represent a pixel or a value of a pixel, may represent only a pixel/pixel value of a luma component or represent only a pixel/pixel value of a chroma component. A sample may be used as a term corresponding to one picture (or image) for a pixel or a pel.

In the encoding apparatus 200, a prediction signal (predicted block, prediction sample array) output from the inter predictor 221 or the intra predictor 222 is subtracted from an input image signal (original block, original sample array) to generate a residual signal residual block, residual sample array), and the generated residual signal is transmitted to the transformer 232. In this case, as shown, a unit for subtracting a prediction signal (predicted block, prediction sample array) from the input image signal (original block, original sample array) in the encoder 200 may be called a subtractor 231. The predictor may perform prediction on a block to be processed (hereinafter, referred to as a current block) and generate a predicted block including prediction samples for the current block. The predictor may determine whether intra prediction or inter prediction is applied on a current block or CU basis. As described later in the description of each prediction mode, the predictor may generate various information related to prediction, such as prediction mode information, and transmit the generated information to the entropy encoder 240. The information on the prediction may be encoded in the entropy encoder 240 and output in the form of a bitstream.

The intra predictor 222 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 222 may determine the prediction mode applied to the current block by using a prediction mode applied to a neighboring block.

The inter predictor 221 may derive a predicted block for the current block based on a reference block (reference sample array) specified by a motion vector on a reference picture. Here, in order to reduce the amount of motion information transmitted in the inter prediction mode, the motion information may be predicted in units of blocks, sub-blocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like, and the reference picture including the temporal neighboring block may be called a collocated picture (colPic). For example, the inter predictor 221 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 221 may use motion information of the neighboring block as motion information of the current block. In the skip mode, unlike the merge mode, the residual signal may not be transmitted. In the case of the motion vector prediction (MVP) mode, the motion vector of the neighboring block may be used as a motion vector predictor and the motion vector of the current block may be indicated by signaling a motion vector difference.

The predictor 220 may generate a prediction signal based on various prediction methods described below. For example, the predictor may not only apply intra prediction or inter prediction to predict one block but also simultaneously apply both intra prediction and inter prediction. This may be called combined inter and intra prediction (CIIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in the present disclosure. The palette mode may be considered as an example of intra coding or intra prediction. When the palette mode is applied, a sample value within a picture may be signaled based on information on the palette table and the palette index.

The prediction signal generated by the predictor (including the inter predictor 221 and/or the intra predictor 222) may be used to generate a reconstructed signal or to generate a residual signal. The transformer 232 may generate transform coefficients by applying a transform technique to the residual signal. For example, the transform technique may include at least one of a discrete cosine transform (DCT), a discrete sine transform (DST), a karhunen-loéve transform (KLT), a graph-based transform (GBT), or a conditionally non-linear transform (CNT). Here, the GBT means transform obtained from a graph when relationship information between pixels is represented by the graph. The CNT refers to transform generated based on a prediction signal generated using all previously reconstructed pixels. In addition, the transform process may be applied to square pixel blocks having the same size or may be applied to blocks having a variable size rather than square.

The quantizer 233 may quantize the transform coefficients and transmit them to the entropy encoder 240 and the entropy encoder 240 may encode the quantized signal (information on the quantized transform coefficients) and output a bitstream. The information on the quantized transform coefficients may be referred to as residual information. The quantizer 233 may rearrange block type quantized transform coefficients into a one-dimensional vector form based on a coefficient scanning order and generate information on the quantized transform coefficients based on the quantized transform coefficients in the one-dimensional vector form. Information on transform coefficients may be generated. The entropy encoder 240 may perform various encoding methods such as, for example, exponential Golomb, context-adaptive variable length coding (CAVLC), context-adaptive binary arithmetic coding (CABAC), and the like. The entropy encoder 240 may encode information necessary for video/image reconstruction other than quantized transform coefficients (ex. values of syntax elements, etc.) together or separately. Encoded information (ex. encoded video/image information) may be transmitted or stored in units of NALs (network abstraction layer) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. In the present disclosure, information and/or syntax elements transmitted/signaled from the encoding apparatus to the decoding apparatus may be included in video/picture information. The video/image information may be encoded through the above-described encoding procedure and included in the bitstream. The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 240 and/or a storage unit (not shown) storing the signal may be included as internal/external element of the encoding apparatus 200, and alternatively, the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transformer 235. The adder 250 adds the reconstructed residual signal to the prediction signal output from the inter predictor 221 or the intra predictor 222 to generate a reconstructed signal (reconstructed picture, reconstructed block, reconstructed sample array). If there is no residual for the block to be processed, such as a case where the skip mode is applied, the predicted block may be used as the reconstructed block. The adder 250 may be called a reconstructor or a reconstructed block generator. The generated reconstructed signal may be used for intra prediction of a next block to be processed in the current picture and may be used for inter prediction of a next picture through filtering as described below.

Meanwhile, luma mapping with chroma scaling (LMCS) may be applied during picture encoding and/or reconstruction.

The filter 260 may improve subjective/objective image quality by applying filtering to the reconstructed signal. For example, the filter 260 may generate a modified reconstructed picture by applying various filtering methods to the reconstructed picture and store the modified reconstructed picture in the memory 270, specifically, a DPB of the memory 270. The various filtering methods may include, for example, deblocking filtering, a sample adaptive offset, an adaptive loop filter, a bilateral filter, and the like. The filter 260 may generate various information related to the filtering and transmit the generated information to the entropy encoder 240 as described later in the description of each filtering method. The information related to the filtering may be encoded by the entropy encoder 240 and output in the form of a bitstream.

The modified reconstructed picture transmitted to the memory 270 may be used as the reference picture in the inter predictor 221. When the inter prediction is applied through the encoding apparatus, prediction mismatch between the encoding apparatus 200 and the decoding apparatus 300 may be avoided and encoding efficiency may be improved.

The DPB of the memory 270 DPB may store the modified reconstructed picture for use as a reference picture in the inter predictor 221. The memory 270 may store the motion information of the block from which the motion information in the current picture is derived (or encoded) and/or the motion information of the blocks in the picture that have already been reconstructed. The stored motion information may be transmitted to the inter predictor 221 and used as the motion information of the spatial neighboring block or the motion information of the temporal neighboring block. The memory 270 may store reconstructed samples of reconstructed blocks in the current picture and may transfer the reconstructed samples to the intra predictor 222.

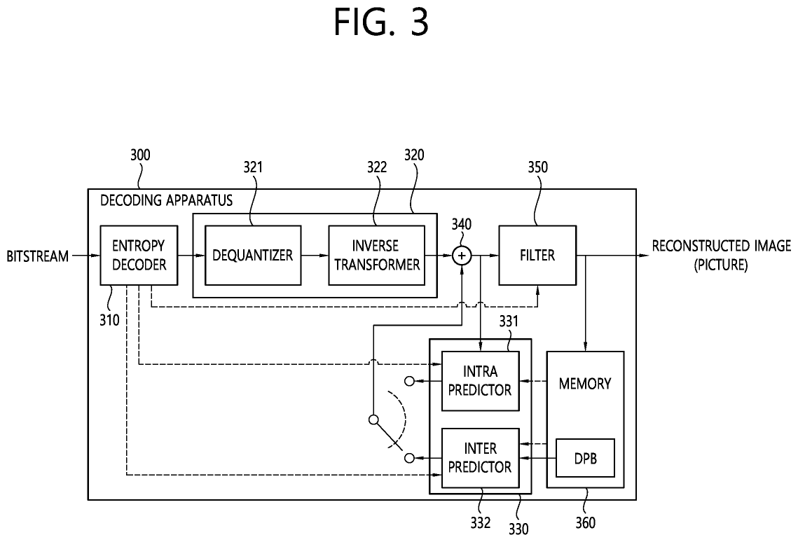

FIG. 3 is a schematic diagram illustrating a configuration of a video/image decoding apparatus to which the embodiment(s) of the present disclosure may be applied.

Referring to FIG. 3, the decoding apparatus 300 may include an entropy decoder 310, a residual processor 320, a predictor 330, an adder 340, a filter 350, a memory 360. The predictor 330 may include an inter predictor 331 and an intra predictor 332. The residual processor 320 may include a dequantizer 321 and an inverse transformer 321. The entropy decoder 310, the residual processor 320, the predictor 330, the adder 340, and the filter 350 may be configured by a hardware component (ex. A decoder chipset or a processor) according to an embodiment. In addition, the memory 360 may include a decoded picture buffer (DPB) or may be configured by a digital storage medium. The hardware component may further include the memory 360 as an internal/external component.

When a bitstream including video/image information is input, the decoding apparatus 300 may reconstruct an image corresponding to a process in which the video/image information is processed in the encoding apparatus of FIG. 2. For example, the decoding apparatus 300 may derive units/blocks based on block partition related information obtained from the bitstream. The decoding apparatus 300 may perform decoding using a processor applied in the encoding apparatus. Thus, the processor of decoding may be a coding unit, for example, and the coding unit may be partitioned according to a quad tree structure, binary tree structure and/or ternary tree structure from the coding tree unit or the largest coding unit. One or more transform units may be derived from the coding unit. The reconstructed image signal decoded and output through the decoding apparatus 300 may be reproduced through a reproducing apparatus.

The decoding apparatus 300 may receive a signal output from the encoding apparatus of FIG. 2 in the form of a bitstream, and the received signal may be decoded through the entropy decoder 310. For example, the entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The decoding apparatus may further decode picture based on the information on the parameter set and/or the general constraint information. Signaled/received information and/or syntax elements described later in the present disclosure may be decoded may decode the decoding procedure and obtained from the bitstream. For example, the entropy decoder 310 decodes the information in the bitstream based on a coding method such as exponential Golomb coding, CAVLC, or CABAC, and output syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a decoding target block or information of a symbol/bin decoded in a previous stage, and perform an arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 310 may be provided to the predictor (the inter predictor 332 and the intra predictor 331), and the residual value on which the entropy decoding was performed in the entropy decoder 310, that is, the quantized transform coefficients and related parameter information, may be input to the residual processor 320. The residual processor 320 may derive the residual signal (the residual block, the residual samples, the residual sample array). In addition, information on filtering among information decoded by the entropy decoder 310 may be provided to the filter 350. Meanwhile, a receiver (not shown) for receiving a signal output from the encoding apparatus may be further configured as an internal/external element of the decoding apparatus 300, or the receiver may be a component of the entropy decoder 310. Meanwhile, the decoding apparatus according to the present disclosure may be referred to as a video/image/picture decoding apparatus, and the decoding apparatus may be classified into an information decoder (video/image/picture information decoder) and a sample decoder (video/image/picture sample decoder). The information decoder may include the entropy decoder 310, and the sample decoder may include at least one of the dequantizer 321, the inverse transformer 322, the adder 340, the filter 350, the memory 360, the inter predictor 332, and the intra predictor 331.

The dequantizer 321 may dequantize the quantized transform coefficients and output the transform coefficients. The dequantizer 321 may rearrange the quantized transform coefficients in the form of a two-dimensional block form. In this case, the rearrangement may be performed based on the coefficient scanning order performed in the encoding apparatus. The dequantizer 321 may perform dequantization on the quantized transform coefficients by using a quantization parameter (ex. quantization step size information) and obtain transform coefficients.

The inverse transformer 322 inversely transforms the transform coefficients to obtain a residual signal (residual block, residual sample array).

The predictor may perform prediction on the current block and generate a predicted block including prediction samples for the current block. The predictor may determine whether intra prediction or inter prediction is applied to the current block based on the information on the prediction output from the entropy decoder 310 and may determine a specific intra/inter prediction mode.

The predictor 320 may generate a prediction signal based on various prediction methods described below. For example, the predictor may not only apply intra prediction or inter prediction to predict one block but also simultaneously apply intra prediction and inter prediction. This may be called combined inter and intra prediction (CIIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in the present disclosure. The palette mode may be considered as an example of intra coding or intra prediction. When the palette mode is applied, a sample value within a picture may be signaled based on information on the palette table and the palette index.

The intra predictor 331 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The intra predictor 331 may determine the prediction mode applied to the current block by using a prediction mode applied to a neighboring block.

The inter predictor 332 may derive a predicted block for the current block based on a reference block (reference sample array) specified by a motion vector on a reference picture. In this case, in order to reduce the amount of motion information transmitted in the inter prediction mode, motion information may be predicted in units of blocks, sub-blocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 332 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 340 may generate a reconstructed signal (reconstructed picture, reconstructed block, reconstructed sample array) by adding the obtained residual signal to the prediction signal (predicted block, predicted sample array) output from the predictor (including the inter predictor 332 and/or the intra predictor 331). If there is no residual for the block to be processed, such as when the skip mode is applied, the predicted block may be used as the reconstructed block.

The adder 340 may be called reconstructor or a reconstructed block generator. The generated reconstructed signal may be used for intra prediction of a next block to be processed in the current picture, may be output through filtering as described below, or may be used for inter prediction of a next picture.

Meanwhile, luma mapping with chroma scaling (LMCS) may be applied in the picture decoding process.

The filter 350 may improve subjective/objective image quality by applying filtering to the reconstructed signal. For example, the filter 350 may generate a modified reconstructed picture by applying various filtering methods to the reconstructed picture and store the modified reconstructed picture in the memory 360, specifically, a DPB of the memory 360. The various filtering methods may include, for example, deblocking filtering, a sample adaptive offset, an adaptive loop filter, a bilateral filter, and the like.

The (modified) reconstructed picture stored in the DPB of the memory 360 may be used as a reference picture in the inter predictor 332. The memory 360 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 360 may store reconstructed samples of reconstructed blocks in the current picture and transfer the reconstructed samples to the intra predictor 331.

In the present document, the embodiments described in the filter 260, the inter predictor 221, and the intra predictor 222 of the encoding apparatus 200 may be the same as or respectively applied to correspond to the filter 350, the inter predictor 332, and the intra predictor 331 of the decoding apparatus 300. The same may also apply to the unit 332 and the intra predictor 331.

As described above, in video coding, prediction is performed to increase compression efficiency. Through this, it is possible to generate a predicted block including prediction samples for a current block, which is a block to be coded. Here, the predicted block includes prediction samples in a spatial domain (or pixel domain) The predicted block is derived equally from the encoding device and the decoding device, and the encoding device decodes information (residual information) on the residual between the original block and the predicted block, not the original sample value of the original block itself. By signaling to the device, image coding efficiency can be increased. The decoding apparatus may derive a residual block including residual samples based on the residual information, and generate a reconstructed block including reconstructed samples by summing the residual block and the predicted block, and generate a reconstructed picture including reconstructed blocks.

The residual information may be generated through transformation and quantization processes. For example, the encoding apparatus may derive a residual block between the original block and the predicted block, and perform a transform process on residual samples (residual sample array) included in the residual block to derive transform coefficients, and then, by performing a quantization process on the transform coefficients, derive quantized transform coefficients to signal the residual related information to the decoding apparatus (via a bitstream). Here, the residual information may include location information, a transform technique, a transform kernel, and a quantization parameter, value information of the quantized transform coefficients etc. The decoding apparatus may perform dequantization/inverse transformation process based on the residual information and derive residual samples (or residual blocks). The decoding apparatus may generate a reconstructed picture based on the predicted block and the residual block. The encoding apparatus may also dequantize/inverse transform the quantized transform coefficients for reference for inter prediction of a later picture to derive a residual block, and generate a reconstructed picture based thereon.

In this document, at least one of quantization/inverse quantization and/or transform/inverse transform may be omitted. When the quantization/inverse quantization is omitted, the quantized transform coefficient may be referred to as a transform coefficient. When the transform/inverse transform is omitted, the transform coefficients may be called coefficients or residual coefficients, or may still be called transform coefficients for uniformity of expression.

In this document, a quantized transform coefficient and a transform coefficient may be referred to as a transform coefficient and a scaled transform coefficient, respectively. In this case, the residual information may include information on transform coefficient(s), and the information on the transform coefficient(s) may be signaled through residual coding syntax. Transform coefficients may be derived based on the residual information (or information about the transform coefficient(s)), and scaled transform coefficients may be derived through inverse transform (scaling) on the transform coefficients. Residual samples may be derived based on an inverse transform (transform) of the scaled transform coefficients. This may be applied/expressed in other parts of this document as well.

Intra prediction may refer to prediction that generates prediction samples for the current block based on reference samples in a picture to which the current block belongs (hereinafter, referred to as a current picture). When intra prediction is applied to the current block, neighboring reference samples to be used for intra prediction of the current block may be derived. The neighboring reference samples of the current block may include samples adjacent to the left boundary of the current block having a size of nW×nH and a total of 2×nH samples neighboring the bottom-left, samples adjacent to the top boundary of the current block and a total of 2×nW samples neighboring the top-right, and one sample neighboring the top-left of the current block. Alternatively, the neighboring reference samples of the current block may include a plurality of upper neighboring samples and a plurality of left neighboring samples. In addition, the neighboring reference samples of the current block may include a total of nH samples adjacent to the right boundary of the current block having a size of nW×nH, a total of nW samples adjacent to the bottom boundary of the current block, and one sample neighboring (bottom-right) neighboring bottom-right of the current block.

However, some of the neighboring reference samples of the current block may not be decoded yet or available. In this case, the decoder may configure the neighboring reference samples to use for prediction by substituting the samples that are not available with the available samples. Alternatively, neighboring reference samples to be used for prediction may be configured through interpolation of the available samples.

When the neighboring reference samples are derived, (i) the prediction sample may be derived based on the average or interpolation of neighboring reference samples of the current block, and (ii) the prediction sample may be derived based on the reference sample present in a specific (prediction) direction for the prediction sample among the periphery reference samples of the current block. The case of (i) may be called non-directional mode or non-angular mode and the case of (ii) may be called directional mode or angular mode.

Furthermore, the prediction sample may also be generated through interpolation between the second neighboring sample and the first neighboring sample located in a direction opposite to the prediction direction of the intra prediction mode of the current block based on the prediction sample of the current block among the neighboring reference samples. The above case may be referred to as linear interpolation intra prediction (LIP). In addition, chroma prediction samples may be generated based on luma samples using a linear model. This case may be called LM mode.

In addition, a temporary prediction sample of the current block may be derived based on filtered neighboring reference samples, and at least one reference sample derived according to the intra prediction mode among the existing neighboring reference samples, that is, unfiltered neighboring reference samples, and the temporary prediction sample may be weighted-summed to derive the prediction sample of the current block. The above case may be referred to as position dependent intra prediction (PDPC).

In addition, a reference sample line having the highest prediction accuracy among the neighboring multi-reference sample lines of the current block may be selected to derive the prediction sample by using the reference sample located in the prediction direction on the corresponding line, and then the reference sample line used herein may be indicated (signaled) to the decoding apparatus, thereby performing intra-prediction encoding. The above case may be referred to as multi-reference line (MRL) intra prediction or MRL based intra prediction.

In addition, intra prediction may be performed based on the same intra prediction mode by dividing the current block into vertical or horizontal subpartitions, and neighboring reference samples may be derived and used in the subpartition unit. That is, in this case, the intra prediction mode for the current block is equally applied to the subpartitions, and the intra prediction performance may be improved in some cases by deriving and using the neighboring reference samples in the subpartition unit. Such a prediction method may be called intra subpartitions (ISP) or ISP based intra prediction.

The above-described intra prediction methods may be called an intra prediction type separately from the intra prediction mode. The intra prediction type may be called in various terms such as an intra prediction technique or an additional intra prediction mode. For example, the intra prediction type (or additional intra prediction mode) may include at least one of the above-described LIP, PDPC, MRL, and ISP. A general intra prediction method except for the specific intra prediction type such as LIP, PDPC, MRL, or ISP may be called a normal intra prediction type. The normal intra prediction type may be generally applied when the specific intra prediction type is not applied, and prediction may be performed based on the intra prediction mode described above. Meanwhile, post-filtering may be performed on the predicted sample derived as needed.

Specifically, the intra prediction procedure may include an intra prediction mode/type determination step, a neighboring reference sample derivation step, and an intra prediction mode/type based prediction sample derivation step. In addition, a post-filtering step may be performed on the predicted sample derived as needed.

When intra prediction is applied, the intra prediction mode applied to the current block may be determined using the intra prediction mode of the neighboring block. For example, the decoding apparatus may select one of most probable mode (mpm) candidates of an mpm list derived based on the intra prediction mode of the neighboring block (ex. left and/or upper neighboring blocks) of the current block based on the received mpm index and select one of the other remaining intro prediction modes not included in the mpm candidates (and planar mode) based on the remaining intra prediction mode information. The mpm list may be configured to include or not include a planar mode as a candidate. For example, if the mpm list includes the planar mode as a candidate, the mpm list may have six candidates. If the mpm list does not include the planar mode as a candidate, the mpm list may have three candidates. When the mpm list does not include the planar mode as a candidate, a not planar flag (ex. intra_luma_not_planar_flag) indicating whether an intra prediction mode of the current block is not the planar mode may be signaled. For example, the mpm flag may be signaled first, and the mpm index and not planar flag may be signaled when the value of the mpm flag is 1. In addition, the mpm index may be signaled when the value of the not planar flag is 1. Here, the mpm list is configured not to include the planar mode as a candidate does not is to signal the not planar flag first to check whether it is the planar mode first because the planar mode is always considered as mpm.

For example, whether the intra prediction mode applied to the current block is in mpm candidates (and planar mode) or in remaining mode may be indicated based on the mpm flag (ex. Intra_luma_mpm_flag). A value 1 of the mpm flag may indicate that the intra prediction mode for the current block is within mpm candidates (and planar mode), and a value 0 of the mpm flag may indicate that the intra prediction mode for the current block is not in the mpm candidates (and planar mode). The value 0 of the not planar flag (ex.

Intra_luma_not_planar_flag) may indicate that the intra prediction mode for the current block is planar mode, and the value 1 of the not planar flag value may indicate that the intra prediction mode for the current block is not the planar mode. The mpm index may be signaled in the form of an mpm_idx or intra_luma_mpm_idx syntax element, and the remaining intra prediction mode information may be signaled in the form of a rem_intra_luma_pred_mode or intra_luma_mpm_remainder syntax element. For example, the remaining intra prediction mode information may index remaining intra prediction modes not included in the mpm candidates (and planar mode) among all intra prediction modes in order of prediction mode number to indicate one of them. The intra prediction mode may be an intra prediction mode for a luma component (sample). Hereinafter, intra prediction mode information may include at least one of the mpm flag (ex. Intra_luma_mpm_flag), the not planar flag (ex.

Intra_luma_not_planar_flag), the mpm index (ex. mpm_idx or intra_luma_mpm_idx), and the remaining intra prediction mode information (rem_intra_luma_pred_mode or intra_luma_mpm_remainder). In the present document, the MPM list may be referred to in various terms such as MPM candidate list and candModeList. When MIP is applied to the current block, a separate mpm flag (ex. intra_mip_mpm_flag), an mpm index (ex. intra_mip_mpm_idx), and remaining intra prediction mode information (ex. intra_mip_mpm_remainder) for MIP may be signaled and the not planar flag is not signaled.

In other words, in general, when block splitting is performed on an image, a current block and a neighboring block to be coded have similar image characteristics. Therefore, the current block and the neighboring block have a high probability of having the same or similar intra prediction mode. Thus, the encoder may use the intra prediction mode of the neighboring block to encode the intra prediction mode of the current block.

For example, the encoder/decoder may configure a list of most probable modes (MPM) for the current block. The MPM list may also be referred to as an MPM candidate list. Herein, the MPM may refer to a mode used to improve coding efficiency in consideration of similarity between the current block and neighboring block in intra prediction mode coding. As described above, the MPM list may be configured to include the planar mode or may be configured to exclude the planar mode. For example, when the MPM list includes the planar mode, the number of candidates in the MPM list may be 6. And, if the MPM list does not include the planar mode, the number of candidates in the MPM list may be 5.

The encoder/decoder may configure an MPM list including 5 or 6 MPMs.

In order to configure the MPM list, three types of modes can be considered: default intra modes, neighbor intra modes, and the derived intra modes.

For the neighboring intra modes, two neighboring blocks, i.e., a left neighboring block and an upper neighboring block, may be considered.

As described above, if the MPM list is configured not to include the planar mode, the planar mode is excluded from the list, and the number of MPM list candidates may be set to 5.

In addition, the non-directional mode (or non-angular mode) among the intra prediction modes may include a DC mode based on the average of neighboring reference samples of the current block or a planar mode based on interpolation.

When inter prediction is applied, the predictor of the encoding apparatus/decoding apparatus may derive a prediction sample by performing inter prediction in units of blocks. Inter prediction may be a prediction derived in a manner that is dependent on data elements (ex. sample values or motion information) of picture(s) other than the current picture. When inter prediction is applied to the current block, a predicted block (prediction sample array) for the current block may be derived based on a reference block (reference sample array) specified by a motion vector on the reference picture indicated by the reference picture index. Here, in order to reduce the amount of motion information transmitted in the inter prediction mode, the motion information of the current block may be predicted in units of blocks, subblocks, or samples based on correlation of motion information between the neighboring block and the current block. The motion information may include a motion vector and a reference picture index. The motion information may further include inter prediction type (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like, and the reference picture including the temporal neighboring block may be called a collocated picture (colPic). For example, a motion information candidate list may be configured based on neighboring blocks of the current block, and flag or index information indicating which candidate is selected (used) may be signaled to derive a motion vector and/or a reference picture index of the current block. Inter prediction may be performed based on various prediction modes. For example, in the case of a skip mode and a merge mode, the motion information of the current block may be the same as motion information of the neighboring block. In the skip mode, unlike the merge mode, the residual signal may not be transmitted. In the case of the motion vector prediction (MVP) mode, the motion vector of the selected neighboring block may be used as a motion vector predictor and the motion vector of the current block may be signaled. In this case, the motion vector of the current block may be derived using the sum of the motion vector predictor and the motion vector difference.

The motion information may include L0 motion information and/or L1 motion information according to an inter prediction type (L0 prediction, L1 prediction, Bi prediction, etc.). The motion vector in the L0 direction may be referred to as an L0 motion vector or MVL0, and the motion vector in the L1 direction may be referred to as an L1 motion vector or MVL1. Prediction based on the L0 motion vector may be called L0 prediction, prediction based on the L1 motion vector may be called L1 prediction, and prediction based on both the L0 motion vector and the L1 motion vector may be called bi-prediction. Here, the L0 motion vector may indicate a motion vector associated with the reference picture list L0 (L0), and the L1 motion vector may indicate a motion vector associated with the reference picture list L1 (L1). The reference picture list L0 may include pictures that are earlier in output order than the current picture as reference pictures, and the reference picture list L1 may include pictures that are later in the output order than the current picture. The previous pictures may be called forward (reference) pictures, and the subsequent pictures may be called reverse (reference) pictures. The reference picture list L0 may further include pictures that are later in the output order than the current picture as reference pictures. In this case, the previous pictures may be indexed first in the reference picture list L0 and the subsequent pictures may be indexed later. The reference picture list L1 may further include previous pictures in the output order than the current picture as reference pictures. In this case, the subsequent pictures may be indexed first in the reference picture list 1 and the previous pictures may be indexed later. The output order may correspond to picture order count (POC) order.

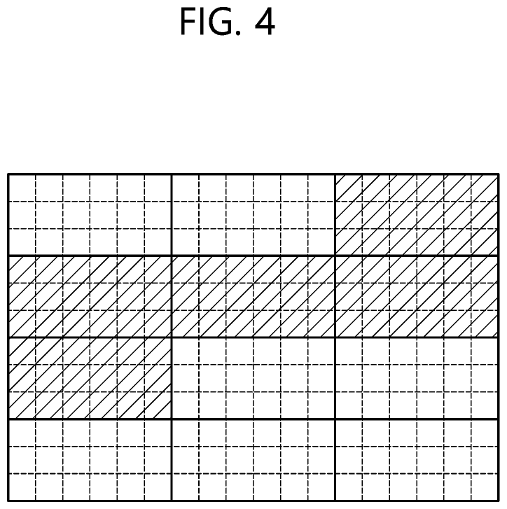

FIG. 4 exemplarily shows a picture including CTUs. In the picture of FIG. 4, rectangles separated by dotted lines may indicate CTUs, rectangles separated by thick lines may indicate tiles, and shaded areas may indicate tile groups (or slices). In the video/image coding according to this document, the image processing unit may have a hierarchical structure. One picture may be classified into one or more tiles, or tile groups. One tile group (or one slice) may include one or more tiles. One tile may include one or more CTUs. The CTU may be partitioned into one or more CUs. A rectangular region of CTUs within a particular tile column and a particular tile row in a picture. The tile group may include an integer number of tiles according to a tile raster scan in the picture. The tile group header may carry information/parameters that may be applied to the corresponding tile group. If the encoding/decoding apparatus has a multi-core processor, the encoding/decoding process for the tile, or tile group may be parallel-processed. Here, the tile group may have one of tile group types including an intra (I) tile group, a predictive (P) tile group, and a bi-predictive (B) tile group. For blocks in the I tile group, inter prediction is not used for prediction, and only intra prediction may be used. Of course, even in this case, the original sample value may be coded and signaled without prediction. For blocks in the P tile group, intra prediction or inter prediction may be used, and when inter prediction is used, only uni prediction may be used. Meanwhile, intra prediction or inter prediction may be used for blocks in the B tile group, and when inter prediction is used, up to the maximum pair (bi) prediction may be used.

The encoder may determine tile/tile groups, largest and smallest coding unit sizes based on the characteristics of the video image (ex. resolution) or in consideration of coding efficiency or parallel-processing, and corresponding information or information for deriving them may be included in the bitstream.

The decoder may obtain information indicating whether a tile/tile group, a CTU in a tile of the current picture is partitioned into a plurality of coding units. When this information is obtained (transmitted) only under certain conditions, efficiency may be increased.

The tile group header (tile group header syntax, or slice header, slice header syntax) may include information/parameters that may be commonly applied to the tile group (or slice). APS (APS syntax) or PPS (PPS syntax) may include information/parameters that may be commonly applied to one or more pictures. The SPS (SPS syntax) may include information/parameters that may be commonly applied to one or more sequences. The VPS (VPS syntax) may include information/parameters that may be commonly applied to multiple layers. In this document, the high level syntax may include at least one of the APS syntax, the PPS syntax, the SPS syntax, and/or the VPS syntax.

Also, for example, information on the partition and configuration of the tile/tile group (or slice) may be configured at an encoding end through the high level syntax and transmitted to the decoding apparatus in the form of a bitstream.

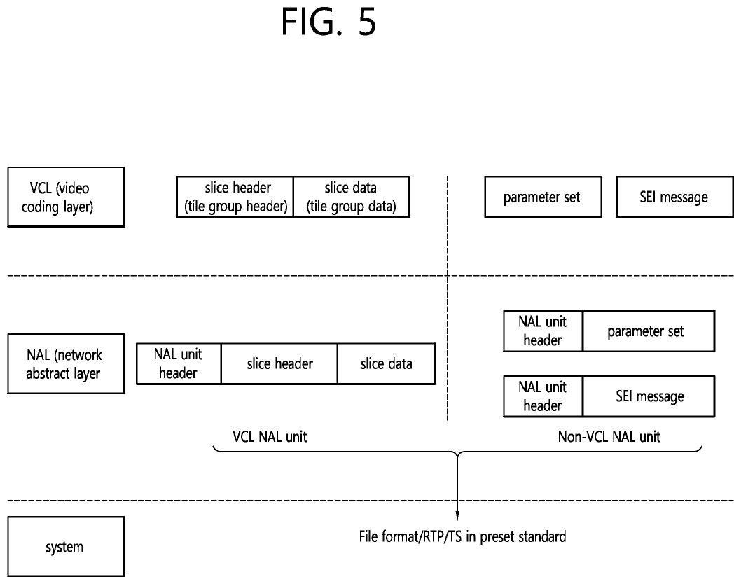

FIG. 5 exemplarily shows a hierarchical structure for a coded image/video.

Referring to FIG. 5, coded image/video is divided into a video coding layer (VCL) that handles the decoding process of the image/video and itself, a subsystem that transmits and stores the coded information, and NAL (network abstraction layer) in charge of function and present between the VCL and the subsystem.

In the VCL, VCL data including compressed image data (slice data) is generated, or a parameter set including a picture parameter set (PSP), a sequence parameter set (SPS), and a video parameter set (VPS) or a supplemental enhancement information (SEI) message additionally required for an image decoding process may be generated.

In the NAL, a NAL unit may be generated by adding header information (NAL unit header) to a raw byte sequence payload (RBSP) generated in a VCL. In this case, the RBSP refers to slice data, parameter set, SEI message, etc., generated in the VCL. The NAL unit header may include NAL unit type information specified according to RBSP data included in the corresponding NAL unit.

As shown in the figure, the NAL unit may be classified into a VCL NAL unit and a Non-VCL NAL unit according to the RBSP generated in the VCL. The VCL NAL unit may mean a NAL unit that includes information on the image (slice data) on the image, and the Non-VCL NAL unit may mean a NAL unit that includes information (parameter set or SEI message) required for decoding the image.

The above-described VCL NAL unit and Non-VCL NAL unit may be transmitted through a network by attaching header information according to the data standard of the subsystem. For example, the NAL unit may be transformed into a data format of a predetermined standard such as an H.266/VVC file format, a real-time transport protocol (RTP), a transport stream (TS), etc., and transmitted through various networks.

As described above, the NAL unit may be specified with the NAL unit type according to the RBSP data structure included in the corresponding NAL unit, and information on the NAL unit type may be stored and signaled in the NAL unit header.

For example, the NAL unit may be classified into a VCL NAL unit type and a Non-VCL NAL unit type according to whether the NAL unit includes information (slice data) about an image. The VCL NAL unit type may be classified according to the nature and type of pictures included in the VCL NAL unit, and the Non-VCL NAL unit type may be classified according to types of parameter sets.

The following is an example of the NAL unit type specified according to the type of parameter set included in the Non-VCL NAL unit type.
APS (Adaptation Parameter Set) NAL unit: Type for NAL unit including APS
DPS (Decoding Parameter Set) NAL unit: Type for NAL unit including DPS
VPS (Video Parameter Set) NAL unit: Type for NAL unit including VPS
SPS(Sequence Parameter Set) NAL unit: Type for NAL unit including SPS
PPS (Picture Parameter Set) NAL unit: Type for NAL unit including PPS
PH (Picture header) NAL unit: Type for NAL unit including PH

The aforementioned NAL unit types may have syntax information for the NAL unit type, and the syntax information may be stored and signaled in a NAL unit header. For example, the syntax information may be nal_unit_type, and NAL unit types may be specified by a nal_unit_type value.

Meanwhile, as described above, one picture may include a plurality of slices, and one slice may include a slice header and slice data. In this case, one picture header may be further added to a plurality of slices (a slice header and a slice data set) in one picture. The picture header (picture header syntax) may include information/parameters commonly applicable to the picture. In the present document, a slice may be mixed or replaced with a tile group. Also, in the present document, a slice header may be mixed or replaced with a tile group header.

The slice header (slice header syntax) may include information/parameters that may be commonly applied to the slice. The APS (APS syntax) or the PPS (PPS syntax) may include information/parameters that may be commonly applied to one or more slices or pictures. The SPS (SPS syntax) may include information/parameters that may be commonly applied to one or more sequences. The VPS (VPS syntax) may include information/parameters that may be commonly applied to multiple layers. The DPS (DPS syntax) may include information/parameters that may be commonly applied to the overall video. The DPS may include information/parameters related to concatenation of a coded video sequence (CVS). The high level syntax (HLS) in the present document may include at least one of the APS syntax, the PPS syntax, the SPS syntax, the VPS syntax, the DPS syntax, and the slice header syntax.

In the present document, the image/image information encoded from the encoding apparatus and signaled to the decoding apparatus in the form of a bitstream includes not only partitioning related information in a picture, intra/inter prediction information, residual information, in-loop filtering information, etc, but also information included in a slice header, information included in the APS, information included in the PPS, information included in an SPS, and/or information included in the VPS.

Meanwhile, in order to compensate for a difference between an original image and a reconstructed image due to an error occurring in a compression coding process such as quantization, an in-loop filtering process may be performed on reconstructed samples or reconstructed pictures as described above. As described above, the in-loop filtering may be performed by the filter of the encoding apparatus and the filter of the decoding apparatus, and a deblocking filter, SAO, and/or adaptive loop filter (ALF) may be applied. For example, the ALF process may be performed after the deblocking filtering process and/or the SAO process are completed. However, even in this case, the deblocking filtering process and/or the SAO process may be omitted.

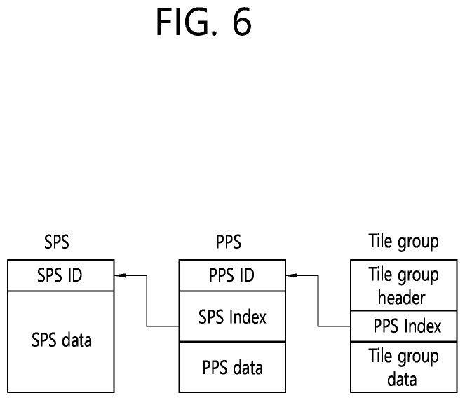

FIG. 6 exemplarily shows a hierarchical structure of CVS.

Referring to FIG. 6, a coded video sequence (CVS) may include an sequence parameter set (SPS), one or more picture parameter sets (PPSs), and one or more coded pictures that follow. Each coded picture may be divided into rectangular regions. The rectangular regions may be referred to as tiles. One or more tiles may be aggregated to form a tile group, a slice, or a subpicture. In this case, the tile group header may be linked to the PPS, and the PPS may be linked to the SPS.

According to an embodiment of the present document, a subpicture may be used to facilitate a sub-bitstream (or a sub-stream) extracted from a bitstream and to combine the sub-bitstreams to form a suitable bitstream. A subpicture may be defined as a rectangular set of one or more tile groups (or slices). For example, one or more tile groups (or slices) may include a tile group (or slice) whose address (i.e., tile_grop_address or slice_address) is 0. Each picture may be divided into one or more subpictures, and each picture may refer to its (corresponding) PPS. Consequently, each subpicture may be partitioned, for example each subpicture may be partitioned into tiles (each subpicture may have tile partitioning).

In an example, information on whether subpictures are present may be included in the SPS. In addition, the SPS may include other sequence level information related to the subpicture. The encoding apparatus and/or the decoding apparatus may process (or control) each subpicture. For example, the encoding apparatus and/or the decoding apparatus may control for each subpicture whether (in)-loop filtering is enabled or disabled across (across) the boundary of the subpicture. As an initial start of subpicture definition, parameters such as subpicture width, height, horizontal offset and vertical offset may be signaled in units of luma samples. The position of the sub picture in the picture is signaled in the SPS. For the benefit of the decoding process, each subpicture must be treated as a picture.

In order to derive the subpicture partitioning structure, parameters such as width, height, horizontal position (horizontal offset), and vertical position (offset) of a subpicture are signaled in units of CTU and/or luma samples. For example, the position of subpictures within a picture may be signaled in the SPS. Parameters related to subpictures will be described in detail with the following tables.

After the subpictures are derived, each subpicture can be treated similarly to a picture. For example, derivation process for motion vector prediction (temporal or spatial, luma or chroma), luma sample bilinear interpolation procedure, luma 8-tap interpolation filtering process and chroma sample interpolation process, in-loop A filtering procedure (i.e., a deblocking filter, a sample adaptive offset (SAO), and an adaptive loop filter (ALF)) may be applied on a subpicture basis.

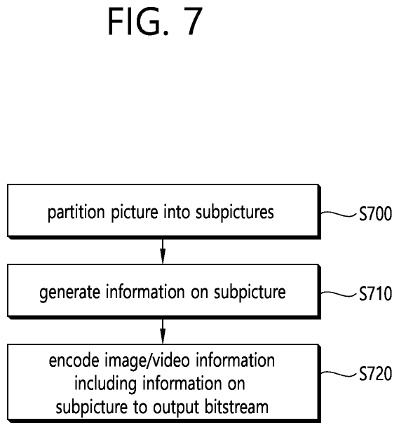

FIG. 7 is a flowchart schematically illustrating an example of a picture encoding method. Referring to FIG. 7, the encoding apparatus may partition an input picture into a plurality of sub pictures (S700). The encoding apparatus may derive a picture partitioning structure based on the sub pictures. The encoding apparatus may generate information on the subpicture (S710). The information on the subpicture may include information (syntax, syntax element) in tables to be described later. For example, information on subpictures includes information indicating whether in-loop filtering is possible across a boundary between subpictures, area information on subpictures (i.e., width, height, horizontal position (offset), and vertical position). (Offset))), information on a tile/tile group included in the subpicture, and entry point information on a tile/tile group included in the subpicture. The encoding apparatus may encode image/video information including information on sub-pictures to output a bitstream (S720). The encoding apparatus may encode one or more subpictures based on information on the subpictures. Each subpicture may be individually encoded and a bitstream based on the encoded subpicture may be output. Here, the bitstream for the subpicture may be referred to as a substream or a subbitstream.

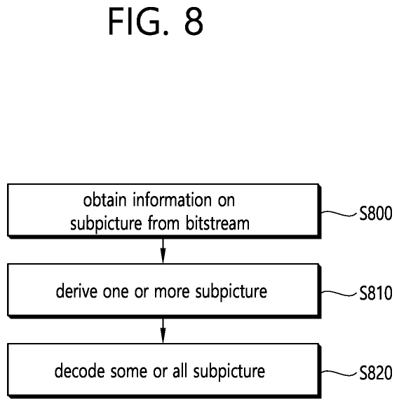

FIG. 8 is a flowchart schematically illustrating an example of a picture decoding method. Referring to FIG. 8, the decoding apparatus may obtain information on a subpicture from a bitstream (S800). The decoding apparatus may decode some or all subpictures and may output some or all of the decoded sub-picture(s). A bitstream may include substream(s) or subbitstream(s) for subpicture(s). As will be described later along with tables, information on a sub-picture may be composed of a high-level syntax (HLS) composed of a bitstream. The decoding apparatus may derive one or more subpictures based on information on the subpictures (S810). The decoder may decode some or all of the subpictures (S810). The decoding apparatus may decode a subpicture based on prediction, residual processing (transform, quantization), and the like, and may output the decoded subpicture(s). In this case, the decoded subpictures of the output subpicture set (OPS) may be output together. For example, if a picture is related to an omnidirectional image so that a part of the image can be rendered, only some subpictures of all subpictures can be decoded and some or all of the decoded subpictures can be rendered by the user. It can be rendered depending on the viewport. When the information indicating whether in-loop filtering is possible across a subpicture boundary indicates that in-loop filtering is possible across a subpicture boundary (enabled or disabled), the decoding device is In-loop filtering (i.e., deblocking filtering, etc.) can be applied. If the subpicture boundary is the same as the picture boundary, the in-loop filtering process for the subpicture boundary may not be applied.

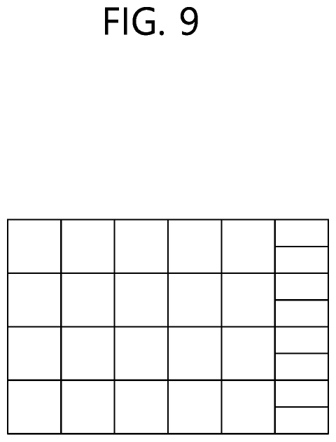

FIG. 9 exemplarily shows a picture including subpictures. Referring to FIG. 9, a picture may be partitioned into 28 sub pictures. In an example, tile groups included in each subpicture may support two modes (i.e., raster-scan tile grouping and/or rectangular tile grouping). In the raster scan tile group mode, a sequence of tiles in the raster scan of a sub picture may be included. In the rectangular tile group mode, a tile group includes multiple tiles of a subpicture that collectively form a rectangular region of the sub-picture. For example, tiles in a rectangular tile group may be in the order of a tile raster scan of the tile group. Subpicture IDs are (explicitly) specified in the SPS and are included in the tile group header to enable extraction of a subpicture sequence that changes a VCL NAL unit.

In one embodiment, one or more subpictures may be included in the output subpicture set. For example, the output subpicture set may have a rectangular shape, and subpictures included in the output subpicture set may have a rectangular shape. Information about the output subpicture set may be included in image information (i.e., a parameter setter), and information on the output subpicture set may be signaled separately from information on the subpicture. In the table below, information on an output subpicture set and information on a subpicture will be described in detail.

The parameter set including information on the subpicture may include example syntax included in the following table. For example, the parameter set may be SPS.

TABLE 1

| | Descriptor |
|---|---|
| seq_parameter_set_rbsp( ) { | |
| sps_max_sub_layers_minus1 | u(3) |
| ... | |
| num_sub_pics_minus1 | ue(v) |
| sub_pic_id_len_minus1 | ue(v) |
| if( num_sub_pics_minus1 > 0 ) | |
| for ( i = 0; i <= num_sub_pics_minus1; i++ ) { | |
| sub_pic_id[ i ] | u(v) |
| if( num_subpics_minus1 > 0 ) { | |
| sub_pic_treated_as_pic_flag[ i ] | u(1) |
| sub_pic_x_offset[ i ] | ue(v) |
| sub_pic_y_offset[ i ] | uc(v) |
| sub_pic_width_in_luma_samples [ i ] | ue(v) |
| sub_pic_height_in luma_samples[ i ] | ue(v) |
| } | |
| } | |
| output_sub_pic_sets_present_flag | u(1) |
| if( output_sub_pic_sets_present_flag ) { | |
| num_osps_format_sets | ue(v) |
| for( i = 0; i < num_osps_format_sets − 1 ; i++ ){ | |
| osps_width_in_luma_samples[ i ] | ue(v) |
| osps_height_in_luma_samples[ i ] | ue(v) |
| profile_tier_level(sps_max_sub_layers_minus1)[ i ] | |
| } | |
| num_output_sub_pic_sets | ue(v) |
| for( i = 0; i < num_output_sub_pic_sets − 1 ; i++ ) { | |
| num_sub_pics_in_osps[ i ] | ue(v) |
| osps_format_set_idx[ i ] | ue(v) |
| for( j = 0; j < num_sub_pics_in_osps − 1 ; j++ ) { | |
| sub_pic_id_in_osps[ i ][ j ] | u(v) |
| } | |
| } | |
| ... | |

The semantics of syntax elements included in the syntax of Table 1 may include, for example, matters disclosed in the following table.

```
TABLE 2
num_sub_pics_minus1 plus 1 specifies the number of sub-pictures in each coded picture in the
CVS. The value of num_sub_pics_minus1 shall be in the range of 0 to 1024, inclusive.
sub_pic_id_len_minus1 plus 1 specifies the number of bits used to represent the syntax element
sub_pic_id[ i ] in the SPS and the syntax element tile_group_sub_pic_id tile group headers. The
value of sub_pic_id_len_minus1 shall be in the range of
Ceil( Log2( num_sub_pic_minus1 + 1 ) − 1 to 9, inclusive.
sub_pic_id[ i ] specifies the sub-picture ID of the i-th sub-picture in each coded picture in the
CVS. The length of sub_pic_id[ i ] is sub_pic_id_len_minus1 + 1 bits.
sub_pic_treated_as_pic_flag[ i ] equal to 1 specifies that the i-th sub-picture of each coded
picture in the CVS is treated as a picture in the decoding process excluding in-loop filtering
operations. sub_pic_treated_as_pic_flag[ i ] equal to 0 specifies that the i-th sub-picture of each
coded picture in the CVS is not treated as a picture in the decoding process excluding in-loop
filtering operations.
sub_pic_x_offset[ i ] specifies the horizontal offset, in units of luma samples, of the top-left
corner luma sample of the i-th sub-picture relative to the top-left corner luma sample of each
picture in the CVS. When not present, the value of sub_pic_x_offset[ i ] is inferred to be equal
to 0. sub_pic_x_offset[ i ] shall be an integer multiple of CtbSizeY.
sub_pic_y_offset[ i ] specifies the vertical offset, in units of luma samples, of the top-left corner
luma sample of the i-th sub-picture relative to the top-left corner luma sample of each picture in
the CVS. When not present, the value of sub_pic_y_offset[ i ] is inferred to be equal to 0.
sub_pic_y_offset[ i ] shall be an integer multiple of CtbSizeY.
sub_pic_width_in_luma_samples[ i ] specifies the width, in units of luma samples, of the i-th
sub-picture of each picture in the CVS. When the sum of sub_pic_x_offset[ i ] and
sub_pic_width_in_luma_samples[ i ] is less than pic_width_in_luma_samples, the value of
sub_pic_width_in_luma_samples[ i ] shall be an integer multiple of CtbSizeY. When not
present, the value of sub_pic_width_in_luma_samples[ i ] is inferred to be equal to
pic_width_in_luma_samples.
sub_pic_height_in_luma_samples[ i ] specifies the height, in units of luma samples, of the i-
th sub-picture for each picture in the CVS. When the sum of sub_pic_y_offset[ i ] and
sub_pic_height_in_luma_samples[ i ] is less than pic_height_in_luma_samples, the value of
sub_pic_height_in_luma_samples[ i ] shall be an integer multiple of CtbSizeY. When not
present, the value of sub_pic_height_in_luma_samples[ i ] is inferred to be equal to
pic_height_in_luma_samples.
It is a requirement of bitstream conformance that the following constraints apply:
  - For any integer values of i and j, when i is equal to j, the values of sub_pic_id[ i ] and
    sub_pic_id[ j ] shall not be the same.
  - For any two sub-pictures subpicA and subpicB, when the sub-picture ID of subpicA is
    less than the sub-picture ID of subpicB, any coded tile group NAL unit of subPicA shall
    succeed any coded tile group NAL unit of subPicB in decoding order.
  - The shapes of the sub-pictures shall be such that each sub-picture, when decoded, shall
    have its entire left boundary and entire top boundary consisting of a picture boundary or
    consisting of boundaries of previously decoded sub-picture(s).
      The list SubPicIdx[ spId ] for spId values equal to sub_pic_id[ i ] with i ranging from 0 to
      num_sub_pics_minus1, inclusive, specifying the conversion from a sub-picture ID to the sub-
      picture index, is derived as follows:
        for( i = 0; i <= num_sub_pics_minus1; i++)
          SubPicIdx[ sub_pic_id[ i ] ] = i
      output_sub_pic_sets_present_flag equal to 1 specifies that output sub-picture sets and HRD
      parameter for each output tile set are present. output_sub_pic_sets_present_flag equal to 0
      specifies that no output sub-picture sets are present.
      num_osps_format_sets specifies the number of output sub-picture set format sets present. The
      value of num_osps_format_sets shall be in the range of 1 to 512. When not present,
      num_osps_format_sets is inferred to be equal to 0.
      osps_width_in_luma_samples[ i ] specifies the width in luma samples of the i-th output sub-
      picture set format.
      osps_height_in_luma_samples[ i ] specifies the height in luma samples of the i-th output sub-
      picture set format.
      profile_tier_level( )[ i ] specifies the profile, tier and level of the i-th output sub-picture set
      format.
      num_output_sub_pic_sets specifies the number of output sub-picture sets present. The value
      of num_output sub_pic_sets shall be in the range of 1 to 512. When not present,
      num_output_sub_pic_sets is inferred to be equal to 0.
      num_sub_pics_in_osps[ i ] specifies the number of sub-pictures in the i-th output sub picture
      set present. The value of num_sub_pics_in_osps[ i ] shall be in the range of 1 to 512. When not
      present, num_sub_pics_in_osps[ i ] is inferred to be equal to 0.
      osps_set_idx[ i ] specifies the index of the output tile set format associated with the i-th output
      tile set. The value of osps_set_idx[ i ] shall be in the range of 1 to num_ots_format_sets − 1.
      sub_pic_id_in_osps[ i ][ j ] specifies the sub-picture ID in the tile group headers of the j-th sub-
      picture belonging to the i-th output sub-picture set.
```

Referring to Tables 1 and 2, information (num_sub_pics_minus1) regarding the number of subpictures may be signaled first in the SPS. The syntax element num_sub_pics_minus1 is variable-length-coded information used to indicate the number of sub pictures in a picture. Then, the SPS parses the length in bits as specified by the syntax element (sub_pic_id_len_minus1) to be used to parse the sub picture id, that is, sub_pic_Id. Then, for each subpicture, a flag (sub_pic_treated_as_pic_flag) that determines whether the subpicture is to be treated as a picture is signaled. That is, if a subpicture is treated as a picture (sub_pic_treated_as_pic_flag equal to 1), picture boundary padding (or other suitable technique) is applied to the subpicture. If sub_pic_treated_as_pic_flag is not valid (sub_pic_treated_as_pic_flag equal to 0), the subpicture may not be treated as a picture during the decoding procedure. In addition, subpicture properties such as position (offset) in the x and y directions and subpicture dimensions of width and height are specified.

In one embodiment, the OSPS present flag output_sub_pic_sets_present_flag may be parsed for use of an output subpicture set (OSPS). If the OSPS presence flag is not available (output_sub_pic_sets_present_flag equal to 0), it is specified that the output subpicture set is not present. If the OSPS present flag is enabled, the number of output subpicture parameter format sets (num_osps_format_sets) is specified, each corresponding set, the width and height of the output subpicture parameter sets, and the corresponding profile/layer level information are specified. In addition, the number of output subpicture sets, that is, num_output_sub_pic_sets, is parsed. For each output subpicture present, the number of subpictures in the output subpictures is determined (num_sup_pics_in_osps[i]). The index of the output tile set format associated with the i-th output tile set is also determined. Also, for each subpicture of the output picture, a corresponding ID (sub_pic_id_in_osps[i][j]) is specified.

In one embodiment, the PPS may include example syntax as shown in the following table.

TABLE 3

| | Descriptor |
|---|---|
| pic_parameter_set_rbsp( ) { | |
| pps_pic_parameter_set_id | ue(v) |
| pps_seq_parameter_set_id | ue(v) |
| loop_filter_across_sub_pic_enabled_flag | u(1) |
| single_tile_in_sub_pic_flag | u(1) |
| if( !single_tile_in_sub_pic_flag ) { | |
| ... | |

The semantics of syntax elements included in the syntax of Table 3 may include, for example, matters disclosed in the following table.

TABLE 4
loop_filter_across_sub_pic_enabled_flag equal to 1 specifies that in-loop filtering
operations may be performed across the boundaries of the sub-picture referring to the PPS.
Ioop_filter_across_sub_pic_enabled_flag equal to 0 specifies that in-loop filtering operations
are not performed across the boundaries of the sub-picture referring to the PPS.
single_tile_in_sub_pic_flag equal to 1 specifies that there is only one tile in each sub-picture
referring to the PPS. single_tile_in_sub_pic_flag equal to 0 specifies that there is more than
one tile in each sub-picture referring to the PPS.

Referring to Tables 3 and 4, a subpicture boundary filtering enabled flag (loop_filter_across_subpic_enabled_flag) indicating that the in-loop filtering operation for the reconstructed samples is performed across a boundary of the subpicture may be included in the PPS. However, an embodiment of the present document is not limited to only the PPS, and the subpicture boundary filtering enable flag may be included in the SPS.

Also, a single tile flag (i.e., single_tile_in_sub_pic_flag) may be included in the PPS. For example, it may be specified that only one tile is included in the subpicture referring to the PPS based on the single tile inclusion flag. However, an embodiment of the present document is not limited to tiles, and may include a single slice flag (single_slice_per_subpic_flag). Whether each subpicture consists of only one rectangular slice may be specified based on the single slice flag.

In one embodiment, the header information may include example syntax as shown in the following table.

TABLE 5

| | Descriptor |
|---|---|
| tile_group_header( ) { | |
| tile_group_pic_parameter_set_id | ue(v) |
| tile_group_sub_pic_id | u(v) |
| if( rect_tile_group_flag \| \| NumTilesInSubPic > 1) | |
| ... | |

The semantics of syntax elements included in the syntax of Table 5 may include, for example, matters disclosed in the following table.

TABLE 6
tile_group_sub_pic_id identifies the sub-picture to which the tile group belongs. The length
of tile_group_sub_pic_id is sub_pic_id_len_minus1 + 1 bits.
The value of tile_group_sub_pic_id shall be the same for all tile groups headers of a coded
sub-picture.

Referring to Tables 5 and 6, the header information may be tile group header information. However, embodiments of the present document are not necessarily limited thereto. For example, the header information of the following table may be replaced with slice header information, and a parameter set ID syntax element and a subpicture ID syntax element included in the header information may be related to a slice.

In one embodiment, the SPS may include example syntax as shown in the following table.

TABLE 7

| | |
|---|---|
| output_sub_pic_sets_present_flag | u(1) |
| if( output_sub_pic_sets_present_flag ) { | |
| num_osps_format_sets | ue(v) |
| resampling_osps_flag | u(1) |
| for( i = 0; i < num_osps_format_sets − 1 ; i++ ){ | |
| if(resampling_osps_flag){ | |
| osps_width_in_luma_samples[ i ] | ue(v) |
| osps_height_in_luma_samples[ i ] | ue(v) |
| } | |
| profile_tier_level(sps_max_sub_layers_minus1)[ i ] | |
| } | |

The semantics of syntax elements included in the syntax of Table 7 may include, for example, matters disclosed in the following table.

TABLE 8
resampling_osps_flag equal to 1 specifies that the output sub-picture sets width and height as
specified by osps_width_in_luma_samples[i] and osps_height_in_luma_samples[i] are present
in the bitstream. resampling_osps_flag equal to 0 specifies that the output sub-picture sets width
and height as specificed by osps_width_in_luma_samples[i] and
osps_height_in_luma_samples[i] will not be present in the bitstream.

Referring to Tables 7 and 8, the SPS may include a resampling flag (resampling_osps_flag) for resampling the width and height of output subpicture sets including the subpictures. For example, when the value of the resampling flag is 1, the SPS includes syntax elements (osps_width_in_luma_samples lip regarding the width of the output subpicture sets and/or syntax elements related to the height of the output subpicture sets. (osps_height_in_luma_samples[i]) may be included in the SPS (can be parsed). When the value of the resampling flag is 1, the syntax elements for the width and syntax elements for the height may not be included in the SPS (may not be parsed). That is, the use of information regarding the width and height of the output subpicture sets may be restricted. In addition, other parameters or syntax elements may be required for additional support for resampling.

According to an embodiment referenced by Tables 7 and 8, in an example, a part of a subpicture may be selected based on the resampling flag, and the selected part of the subpicture may be included in the first output subpicture set. In another example, at least one of the subpictures may be selected based on the resampling flag, and the selected at least one subpicture may be included in the second output subpicture set. In another example, the width and height of the third output subpicture set may be derived based on the resampling flag, and the subpictures included in the region based on the width and height may be included in the third output subpicture set.

In one embodiment, the general constraint information may include example syntax as shown in the following table.

TABLE 9

| | Descriptor |
|---|---|
| general_constraint_info( ) { | |
| ... | |
| general_resampling_constraint_flag | u(1) |
| ... | |

The semantics of syntax elements included in the syntax of Table 9 may include, for example, matters disclosed in the following table.

TABLE 10
general_resampling_constraint_flag equal to 1 indicates that all the sub-pictures in the new
bitstream do not carry any information for resampling. general_resampling_constraint_flag
equal to 1 indicates that all the sub-pictures may carry information for resampling.

Referring to Tables 9 and 10, general constraint information, SPS and/or PPS may include a constraint flag to indicate whether a new combined bitstream formed from the merging of other subpictures is to be resampled. That is, the general restriction information may include a resampling restriction flag (general_resampling_constraint_flag) for the subpictures in the SPS or PPS. The decoding apparatus may signal information on the use of resampling through supplemental enhancement information (SEI) or video usability information (VUI).

The following drawings are created to explain specific examples of the present specification. Since the names of specific apparatus described in the drawings or the names of specific signals/messages/fields are presented by way of example, the technical features of the present specification are not limited to the specific names used in the following drawings.

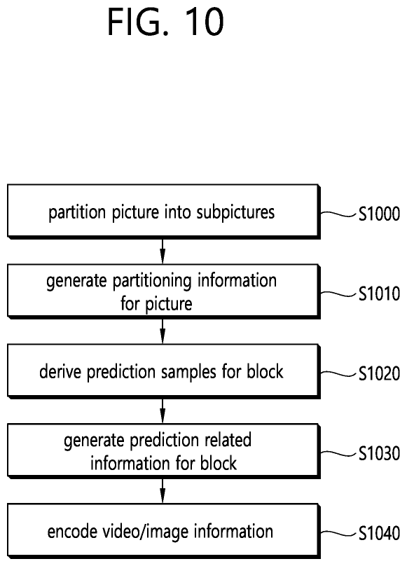

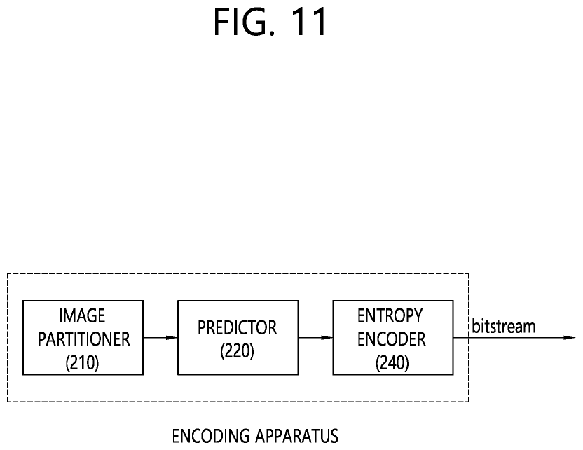

FIG. 10 and FIG. 11 schematically illustrate an example of a video/image encoding method and related components according to embodiment(s) of the present document. The method disclosed in FIG. 10 may be performed by the encoding apparatus disclosed in FIG. 2. Specifically, for example, S1000 and S1010 of FIG. 10 may be performed by the image partitioner 210 of the encoding apparatus, S1020 and S1030 of FIG. 10 may be performed by the predictor 220 of the encoding apparatus, and S1040 of FIG. 10 may be performed by the entropy encoder unit 240 of the encoding apparatus. The method disclosed in FIG. 10 may include the embodiments described above in this document.

The encoding apparatus may partition (divide) the current picture into a plurality of subpictures (S1000). More specifically, the image partitioner 210 of the encoding apparatus may partition (divide) the current picture into a plurality of subpictures.

The encoding apparatus may generate partitioning information for the current picture based on the plurality of sub pictures (S1010). More specifically, the image partitioner 210 of the encoding apparatus may generate partitioning information for the current picture based on the plurality of subpictures. In one example, tile groups included in each subpicture may support two modes (i.e., raster scan tile grouping and/or rectangular tile grouping).

The encoding apparatus may derive prediction samples for a current block included in one subpicture among the plurality of subpictures (S1020). More specifically, the predictor 220 of the encoding apparatus may derive prediction samples for a current block included in one subpicture among the plurality of subpictures.

The encoding apparatus may generate prediction related information on the current block based on the prediction samples (S1030). More specifically, the predictor 220 of the encoding apparatus may generate prediction related information on the current block based on the prediction samples. The prediction related information may include information on various prediction modes (i.e., merge mode, MVP mode, etc.), MVD information, and the like.

The encoding apparatus may encode image/video information including partitioning information on the current picture and prediction information on the current block (S1040). More specifically, an image/video including at least one of partitioning information on the current picture and prediction information on the current block may be encoded. The encoded video/image information may be output in the form of a bitstream. The bitstream may be transmitted to the decoding device through a network or a storage medium.

The image/video information may include various information according to an embodiment of the present document. For example, the image/video information may include information disclosed in at least one of Tables 1, 3, 5, 7, and 9 described above.

The encoding apparatus may generate residual samples based on the prediction samples. The encoding apparatus may generate residual samples based on original samples of the current block and prediction samples of the current block.

The encoding apparatus may derive information on residual samples based on the residual samples and encode image/video information including information on the residual samples. The information on the residual samples may be referred to as residual information, and may include information on quantized transform coefficients. The encoding apparatus may derive quantized transform coefficients by performing a transform/quantization procedure on the residual samples.

In one embodiment, the image information includes an SPS. For example, the SPS includes information on a number of the subpictures for the current picture. The partitioning structure of the current picture is derived based on information on the number of the subpictures (ex. num_sub_pic_minus1 in Table 1).

In one embodiment, the SPS includes ID syntax elements of the subpictures (ex. sub_pic_id[i] in Table 1). For example, the ID syntax elements are derived based on the information on the number of the subpictures.

In one embodiment, the SPS includes a subpicture ID length syntax element (ex. sub_pic_id_len_minus1 in Table 1). For example, a value of the subpicture ID length syntax element plus 1 specifies a number of bits used to represent the ID syntax elements.

In one embodiment, the SPS includes a subpicture treat flag (ex. sub_pic_treated_as_pic_flag in Table 1) specifying that the subpicture is treated as a picture belonging to a decoding process except for an in-loop filtering operation.

In one embodiment, the SPS includes information specifying a horizontal position of a top-left coded tree unit (CTU) of the subpicture (ex. sub_pic_x_offset[i] in Table 1). For example, the horizontal position may be expressed in CTU size units.

In one embodiment, the SPS includes information specifying a vertical position of the top-left CTU of the subpicture (ex. sub_pic_y_offset[i] in Table 1). For example, the vertical position may be expressed in CTU size units.

In one embodiment, the SPS may include subpicture width information (ex. sub_pic_width_in_luma_samples[i] in Table 1). In an example, the width information may specify the width of the subpicture. In another example, the value plus 1 of the width information may specify the width of the subpicture.

In one embodiment, the SPS may include subpicture height information (ex. sub_pic_height_in_luma_samples[i] in Table 1). In an example, the height information of the subpicture may specify the height of the subpicture. In another example, the value plus 1 of the height information of the subpicture may specify the height of the subpicture.

In one embodiment, the image information may include a subpicture boundary filtering enable flag (ex. loop_filter_across_sub_pic_enabled_flag in Table 2) indicating that the in-loop filtering operation for the reconstructed samples is performed across the boundary of the subpicture.

In one embodiment, the image information may include a single tile flag (ex. single_tile_in_sub_pic_flag in Table 2). For example, based on the single tile flag, it may be specified that only one tile is included in the subpicture referring to the PPS.

In one embodiment, the SPS may include an output subpicture sets present flag (ex. output_sub_pic_sets_present_flag in Table 1). For example, based on the output subpicture sets present flag, it may be specified that output subpicture sets including the subpictures is present.

In one embodiment, when the value of the output subpicture sets present flag is 1, the SPS may include information on the number of the output subpicture sets (ex. num_output_sub_pic_sets in Table 1).

In one embodiment, when the value of the output subpicture sets present flag is 1, the SPS includes information on the number of subpictures included in one output subpicture set among the output subpicture sets (ex. num_sub_pics_in_osps[i] in Table 1) may be included.

In one embodiment, when the value of the output subpicture sets present flag is 1, the SPS includes ID syntax elements (ex. sub_pic_id_in_osps[1][j] in Table 1) may be included.

In one embodiment, the SPS may include a resampling flag (ex. resampling_osps_flag in Table 7) for resampling widths and heights of output subpicture sets including subpictures. For example, when the value of the resampling flag is 1, the SPS includes syntax elements related to the width of the output subpicture sets and syntax elements related to the height of the output subpicture sets (ex. osps_width_in_luma_samples[i], osps_height_in_luma_samples[i] in Table 7) may be included. In one example, a part of subpicture may be selected based on the resampling flag, and the selected part of subpicture may be included in the first output sub-picture set. In another example, at least one of the subpictures may be selected based on the resampling flag, and the selected at least one subpicture may be included in the second output subpicture set. In another example, the width and height of the third output subpicture set may be derived based on the resampling flag, and the subpictures included in the region based on the width and height may be included in the third output subpicture set.

In one embodiment, the image information may include general constraint information (general_constraint_info( ) in Table 9). For example, the general constraint information may include a resampling restriction flag (ex. general_resampling_constraint_flag in Table 9) for the subpictures in the SPS or PPS.

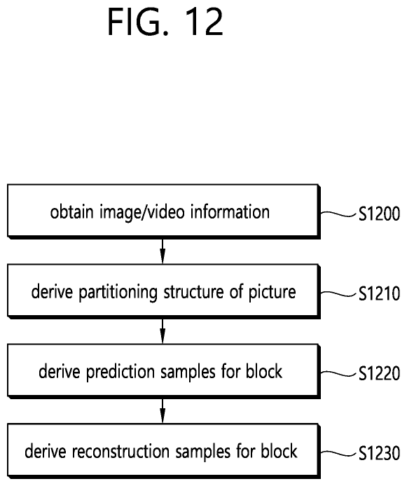

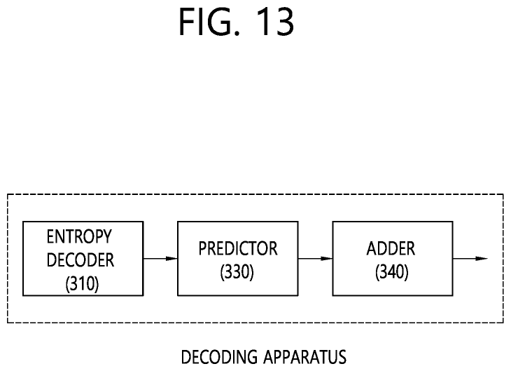

FIG. 12 and FIG. 13 schematically illustrate an example of an image/video decoding method and related components according to an embodiment of the present document. The method disclosed in FIG. 12 may be performed by the decoding apparatus illustrated in FIG. 3. Specifically, for example, S1200 and S1210 of FIG. 12 may be performed by the entropy decoder 310 of the decoding apparatus, S1220 may be performed by the predictor 330 of the decoding apparatus, and S1230 may be performed by the adder 340 of the decoding apparatus. The method disclosed in FIG. 16 may include the embodiments described above in this document.

Referring to FIG. 12, the decoding apparatus may obtain image information including partitioning information for a current picture and prediction related information for a current block included in the current picture from a bitstream (S1200). More specifically, the entropy decoding unit 310 of the decoding apparatus may obtain image information including partitioning information on the current picture and prediction related information on the current block included in the current picture from the bitstream. The prediction related information may include information on various prediction modes (i.e., merge mode, MVP mode, etc.), MVD information, and the like.

The image/video information may include various information according to an embodiment of the present document. For example, the image/video information may include information disclosed in at least one of Tables 1, 3, 5, 7, and 9 described above.

The decoding apparatus may derive a partitioning structure of the current picture based on a plurality of sub pictures based on the division information for the current picture (S1210). More specifically, the entropy decoder 310 of the decoding apparatus may derive a partitioning structure of the current picture based on a plurality of sub pictures based on the partitioning information on the current picture. In one example, tile groups included in each sub-picture may support two modes (i.e., raster scan tile grouping and/or rectangular tile grouping).

The decoding apparatus may derive prediction samples for the current block based on the prediction related information on the current block included in one of the plurality of subpictures (S1220). More specifically, the predictor 330 of the decoding apparatus may derive prediction samples for the current block based on the prediction related information on the current block included in one of the plurality of subpictures. can

The decoding apparatus may derive reconstructed samples for the current block based on the prediction samples (S1230). More specifically, the adder 340 of the decoding apparatus may derive reconstructed samples for the current block based on the prediction samples. As described above, a reconstructed block/picture may be generated based on the reconstructed samples. The decoding apparatus may obtain residual information (including information about quantized transform coefficients) from the bitstream, and may derive residual samples from the residual information, and the reconstructed samples may be generated based on the prediction samples and the residual samples. As described above, an in-loop filtering procedure such as deblocking filtering, SAO, ALF, and/or bidirectional filtering may be applied to the reconstructed picture in order to improve subjective/objective picture quality if necessary.

In one embodiment, the image information includes an SPS. For example, the SPS includes information on a number of the subpictures for the current picture. The partitioning structure of the current picture is derived based on information on the number of the subpictures (ex. num_sub_pic_minus1 in Table 1).

In one embodiment, the SPS includes ID syntax elements of the subpictures (ex. sub_pic_id[i] in Table 1). For example, the ID syntax elements are derived based on the information on the number of the subpictures.

In one embodiment, the SPS includes a subpicture ID length syntax element (ex. sub_pic_id_len_minus1 in Table 1). For example, a value of the subpicture ID length syntax element plus 1 specifies a number of bits used to represent the ID syntax elements.

In one embodiment, the SPS includes a subpicture treat flag (ex. sub_pic_treated_as_pic_flag in Table 1) specifying that the subpicture is treated as a picture belonging to a decoding process except for an in-loop filtering operation.

In one embodiment, the SPS includes information specifying a horizontal position of a top-left coded tree unit (CTU) of the subpicture (ex. sub_pic_x_offset[i] in Table 1). For example, the horizontal position may be expressed in CTU size units.

In one embodiment, the SPS includes information specifying a vertical position of the top-left CTU of the subpicture (ex. sub_pic_y_offset[i] in Table 1). For example, the vertical position may be expressed in CTU size units.

In one embodiment, the SPS may include subpicture width information (ex. sub_pic_width_in_luma_samples[i] in Table 1). In an example, the width information may specify the width of the subpicture. In another example, the value plus 1 of the width information may specify the width of the subpicture.

In one embodiment, the SPS may include subpicture height information (ex. sub_pic_height_in_luma_samples[i] in Table 1). In an example, the height information of the subpicture may specify the height of the subpicture. In another example, the value plus 1 of the height information of the subpicture may specify the height of the subpicture.

In one embodiment, the image information may include a subpicture boundary filtering enable flag (ex. loop_filter_across_sub_pic_enabled_flag in Table 2) indicating that the in-loop filtering operation for the reconstructed samples is performed across the boundary of the subpicture.

In one embodiment, the image information may include a single tile flag (ex. single_tile_in_sub_pic_flag in Table 2). For example, based on the single tile flag, it may be specified that only one tile is included in the subpicture referring to the PPS.

In one embodiment, the SPS may include an output subpicture sets present flag (ex. output_sub_pic_sets_present_flag in Table 1). For example, based on the output subpicture sets present flag, it may be specified that output subpicture sets including the subpictures is present.

In one embodiment, when the value of the output subpicture sets present flag is 1, the SPS may include information on the number of the output subpicture sets (ex. num_output_sub_pic_sets in Table 1).

In one embodiment, when the value of the output subpicture sets present flag is 1, the SPS includes information on the number of subpictures included in one output subpicture set among the output subpicture sets (ex. num_sub_pics_in_osps[i] in Table 1) may be included.

In one embodiment, when the value of the output subpicture sets present flag is 1, the SPS includes ID syntax elements (ex. sub_pic_id_in_osps[1][j] in Table 1) may be included.

In one embodiment, the SPS may include a resampling flag (ex. resampling_osps_flag in Table 7) for resampling widths and heights of output subpicture sets including subpictures. For example, when the value of the resampling flag is 1, the SPS includes syntax elements related to the width of the output subpicture sets and syntax elements related to the height of the output subpicture sets (ex. osps_width_in_luma_samples, osps_height_in_luma_samples[i] in Table 7) may be included. In one example, a part of subpicture may be selected based on the resampling flag, and the selected part of subpicture may be included in the first output sub-picture set. In another example, at least one of the subpictures may be selected based on the resampling flag, and the selected at least one subpicture may be included in the second output subpicture set. In another example, the width and height of the third output subpicture set may be derived based on the resampling flag, and the subpictures included in the region based on the width and height may be included in the third output subpicture set.

In one embodiment, the image information may include general constraint information (general_constraint_info( ) in Table 9). For example, the general constraint information may include a resampling restriction flag (ex. general_resampling_constraint_flag in Table 9) for the subpictures in the SPS or PPS.

In the above-described embodiment, the methods are described based on the flowchart having a series of steps or blocks. The present disclosure is not limited to the order of the above steps or blocks. Some steps or blocks may occur simultaneously or in a different order from other steps or blocks as described above. Further, those skilled in the art will understand that the steps shown in the above flowchart are not exclusive, that further steps may be included, or that one or more steps in the flowchart may be deleted without affecting the scope of the present disclosure.

The method according to the above-described embodiments of the present document may be implemented in software form, and the encoding apparatus and/or decoding apparatus according to the present document is, for example, may be included in the apparatus that performs the image processing of a TV, a computer, a smart phone, a set-top box, a display device, etc.

When the embodiments in the present document are implemented in software, the above-described method may be implemented as a module (process, function, etc.) that performs the above-described function. A module may be stored in a memory and executed by a processor. The memory may be internal or external to the processor, and may be coupled to the processor by various well-known means. The processor may include an application-specific integrated circuit (ASIC), other chipsets, logic circuits, and/or data processing devices. Memory may include read-only memory (ROM), random access memory (RAM), flash memory, memory cards, storage media, and/or other storage devices. That is, the embodiments described in the present document may be implemented and performed on a processor, a microprocessor, a controller, or a chip. For example, the functional units shown in each figure may be implemented and performed on a computer, a processor, a microprocessor, a controller, or a chip. In this case, information on instructions or an algorithm for implementation may be stored in a digital storage medium.

In addition, the decoding apparatus and the encoding apparatus to which the present disclosure is applied may be included in a multimedia broadcasting transmission/reception apparatus, a mobile communication terminal, a home cinema video apparatus, a digital cinema video apparatus, a surveillance camera, a video chatting apparatus, a real-time communication apparatus such as video communication, a mobile streaming apparatus, a storage medium, a camcorder, a VoD service providing apparatus, an Over the top (OTT) video apparatus, an Internet streaming service providing apparatus, a three-dimensional (3D) video apparatus, a teleconference video apparatus, a transportation user equipment (i.e., vehicle user equipment, an airplane user equipment, a ship user equipment, etc.) and a medical video apparatus and may be used to process video signals and data signals. For example, the Over the top (OTT) video apparatus may include a game console, a blue-ray player, an internet access TV, a home theater system, a smart phone, a tablet PC, a Digital Video Recorder (DVR), and the like.

Furthermore, the processing method to which the present document is applied may be produced in the form of a program that is to be executed by a computer and may be stored in a computer-readable recording medium. Multimedia data having a data structure according to the present disclosure may also be stored in computer-readable recording media. The computer-readable recording media include all types of storage devices in which data readable by a computer system is stored. The computer-readable recording media may include a BD, a Universal Serial Bus (USB), ROM, PROM, EPROM, EEPROM, RAM, CD-ROM, a magnetic tape, a floppy disk, and an optical data storage device, for example. Furthermore, the computer-readable recording media includes media implemented in the form of carrier waves (i.e., transmission through the Internet). In addition, a bitstream generated by the encoding method may be stored in a computer-readable recording medium or may be transmitted over wired/wireless communication networks.

In addition, the embodiments of the present document may be implemented with a computer program product according to program codes, and the program codes may be performed in a computer by the embodiments of the present document. The program codes may be stored on a carrier which is readable by a computer.

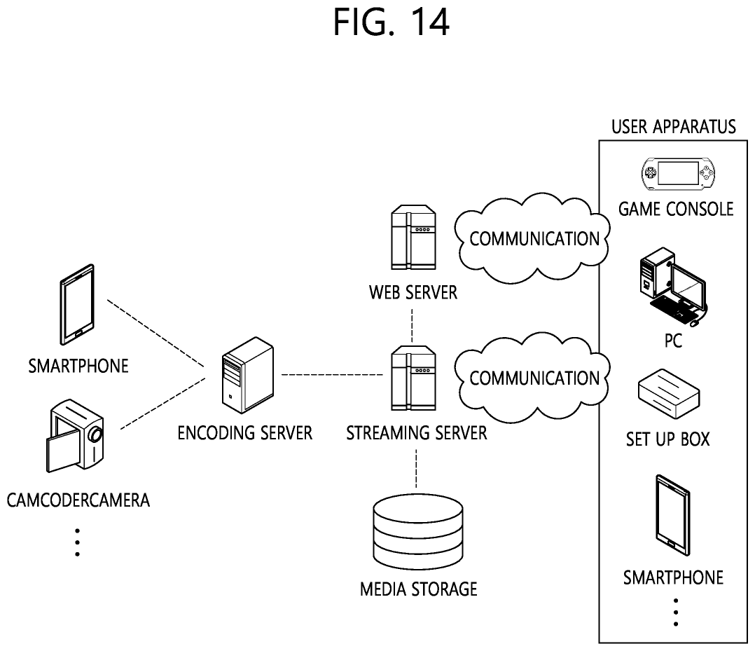

FIG. 14 shows an example of a content streaming system to which embodiments disclosed in the present document may be applied.

Referring to FIG. 14, the content streaming system to which the embodiment(s) of the present document is applied may largely include an encoding server, a streaming server, a web server, a media storage, a user device, and a multimedia input device.

The encoding server compresses content input from multimedia input devices such as a smartphone, a camera, a camcorder, etc. Into digital data to generate a bitstream and transmit the bitstream to the streaming server. As another example, when the multimedia input devices such as smartphones, cameras, camcorders, etc. directly generate a bitstream, the encoding server may be omitted.

The bitstream may be generated by an encoding method or a bitstream generating method to which the embodiment(s) of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server delivers it to a streaming server, and the streaming server transmits multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (ex. Smartwatches, smart glasses, head mounted displays), digital TVs, desktops computer, digital signage, and the like. Each server in the content streaming system may be operated as a distributed server, in which case data received from each server may be distributed.

Each server in the content streaming system may be operated as a distributed server, and in this case, data received from each server may be distributed and processed.

The claims described herein may be combined in various ways. For example, the technical features of the method claims of the present document may be combined and implemented as an apparatus, and the technical features of the apparatus claims of the present document may be combined and implemented as a method. In addition, the technical features of the method claim of the present document and the technical features of the apparatus claim may be combined to be implemented as an apparatus, and the technical features of the method claim of the present document and the technical features of the apparatus claim may be combined and implemented as a method.

What is claimed is:

1. An image decoding method performed by a decoding apparatus, the method comprising:
obtaining, from a bitstream, image information including partitioning information on a current picture and prediction related information on a current block included in the current picture;
deriving a partitioning structure of the current picture based on subpictures, based on the partitioning information for the current picture;
deriving prediction samples for the current block based on the prediction related information on the current block included in one of the subpictures; and
deriving reconstructed samples for the current block based on the prediction samples,
wherein the image information includes a sequence parameter set (SPS),
wherein the SPS includes information on a number of the subpictures for the current picture,
wherein the partitioning structure of the current picture is derived based on information on the number of the subpictures.

2. The method of claim 1, wherein the SPS includes ID syntax elements of the subpictures,
wherein the ID syntax elements are derived based on the information on the number of the subpictures.

3. The method of claim 2, wherein the SPS includes a subpicture ID length syntax element,
wherein a value of the subpicture ID length syntax element plus 1 specifies a number of bits used to represent the ID syntax elements.

4. The method of claim 1, wherein the SPS includes a subpicture treat flag specifying that the subpicture is treated as a picture belonging to a decoding process except for an in-loop filtering operation.

5. The method of claim 1, wherein the SPS includes information specifying a horizontal position of a top-left coded tree unit (CTU) of the subpicture and information specifying a vertical position of the top-left CTU of the subpicture.

6. The method of claim 1, wherein the SPS includes width information of the subpicture and height information of the subpicture,
wherein the width of the subpicture is derived based on the width information,
wherein the height of the subpicture is derived based on the height information.

7. The method of claim 1, wherein the image information includes a subpicture boundary filtering enabled flag specifying that an in-loop filtering operation for the reconstructed samples is performed across a boundary of the subpicture.

8. The method of claim 1, wherein the image information includes a single tile flag,
wherein based on the single tile flag, it is specified that only one tile is included in the subpicture.

9. The method of claim 1, wherein the SPS includes an output subpicture sets present flag,
wherein based on the output subpicture sets present flag, it is specified that the output subpicture sets including the subpictures is present.

10. The method of claim 9, wherein when a value of the output subpicture sets present flag is 1, the SPS includes information on a number of the output subpicture sets.

11. The method of claim 9, wherein when a value of the output subpicture sets present flag is 1, the SPS includes information on a number of subpictures included in one output subpicture set among the output subpicture sets.

12. The method of claim 9, wherein when a value of the output subpicture sets present flag is 1, the SPS includes ID syntax elements of subpictures included in one output subpicture set among the output subpicture sets.

13. The method of claim 1, wherein the SPS includes a resampling flag for resampling a width and a height of the output subpicture sets including the subpictures,
wherein when a value of the resampling flag is 1, the SPS includes syntax elements related to the width of the output subpicture sets and syntax elements related to the height of the output subpicture sets

14. The method of claim 1, wherein the image information includes general constraint information,
wherein the general constraint information includes a resampling constraint flag for the subpictures in the SPS or PPS.

15. An image encoding method performed by an encoding apparatus, the method comprising:
partitioning a current picture into subpictures;
generating partitioning information for the current picture based on the subpictures;
deriving prediction samples for a current block included in one of the subpictures;
generating prediction related information for the current block based on the prediction samples; and
encoding image information including the partitioning information for the current picture and prediction related information for the current block,
wherein the image information includes a sequence parameter set (SPS),
wherein the SPS includes information on a number of the subpictures for the current picture,
wherein the partitioning structure of the current picture is derived based on information on the number of the subpictures.

16. The method of claim 15, wherein the SPS includes ID syntax elements of the subpictures,
wherein the ID syntax elements are derived based on the information on the number of the subpictures.

17. The method of claim 16, wherein the SPS includes a subpicture ID length syntax element,
wherein a value of the subpicture ID length syntax element plus 1 specifies a number of bits used to represent the ID syntax elements.

18. The method of claim 15, wherein the SPS includes a subpicture treat flag specifying that the subpicture is treated as a picture belonging to a decoding process except for an in-loop filtering operation.

19. The method of claim 15, wherein the image information includes a subpicture boundary filtering enabled flag specifying that an in-loop filtering operation for the reconstructed samples is performed across a boundary of the subpicture.

20. A computer-readable digital storage medium, storing encoded information causing a decoding apparatus to perform an image decoding method, the method comprising:
obtaining, from a bitstream, image information including partitioning information on a current picture and prediction related information on a current block included in the current picture;
deriving a partitioning structure of the current picture based on subpictures, based on the partitioning information for the current picture;
deriving prediction samples for the current block based on the prediction related information on the current block included in one of the subpictures; and
deriving reconstructed samples for the current block based on the prediction samples,
wherein the image information includes a sequence parameter set (SPS),
wherein the SPS includes information on a number of the subpictures for the current picture,
wherein the partitioning structure of the current picture is derived based on information on the number of the subpictures.
